(19) United States
(12) Patent Application Publication
(10) Pub. No.: US 2017/0024811 A1
(43) Pub. Date: Jan. 26, 2017

(54) ONLINE AUCTION METHOD WITH ENHANCED SECURITY AND BIDDING OPTIONS

(71) Applicant: Jian Min Liu, Moose Jaw (CA)

(72) Inventor: Jian Min Liu, Moose Jaw (CA)

(21) Appl. No.: 15/065,569

(22) Filed: Mar. 9, 2016

(30) Foreign Application Priority Data
Mar. 9, 2015 (CA) 2884067

(51) Int. Cl. G06Q 30/08; G06Q 30/06

(52) U.S. Cl. CPC G06Q 30/08; G06Q 30/0609

(57) ABSTRACT

A method of conducting an enhanced electronic auction for real estate and other high-value items. Auction parameters including property identification and reserve price data are captured with respect to an auction lot, and stored in an auction profile record in an auction database. Auctions of auction lots listed for sale are conducted via a website system within an auction bidding window. An auction bidding window is extended by a bidding window time extension each time that a current winning bid is received, providing registered bidders with a minimum timeframe to make a highest bid before the auction closes. Registered bidders are required to provide a security deposit to participate in the auction, and the identity or qualifications of sellers is verified.

### FIELD OF THE INVENTION

This invention is in the field of online auction methods. More specifically the invention is a method of conducting an enhanced electronic auction for real estate and other high-value items which includes enhanced transaction handling rules and bidding workflow, in an online environment.

### BACKGROUND OF THE INVENTION

Traditional sales of real estate, and other high-value assets, have necessarily involved complicated sales pipeline and transaction workflows. Currently, many types of real estate assets for example might receive in a traditional context multiple competing offers from various interested buyers. Each offer might have different pricing and conditions associated with it. Sellers need to go through a formal process to respond or counteroffer to offers provided by potential purchasers or buyers. Other buyers might be willing to increase the offer they have made for the purchase of the real estate property but have no opportunity to do so without a counter offer in a traditional context. In addition, in a traditional non-auction context, buyers would normally not be aware of the price that is being offered by other buyers and might be reluctant to initiate an offer for too high a price for the real estate. If purchasors were able to know the current offer price, it might benefit sellers as purchasors might be enticed to make reasonable offers over the current price and maximize profits to the seller.

Even in a traditional context, taking an auction approach removes some of the uncertainties and complications from the real estate sales process. Multiple registered bidders are able to bid on the purchase of a property with the highest bid price being the winner. Traditionally the auction takes place at a physical location within a fixed time window, with the last bidder standing, so to speak, ending up being the ultimate purchaser of the property.

While the auctioning of real estate and other high-value assets such as this does have some benefits which make it attractive, including the fact that all of the bidders on the property can know what the going price is and make their bidding decisions appropriately, the auction process carries its own set of limitations. In a traditional auction for example the bidders all need to aggregate in one location at a fixed time within which to bid on the property. This has limitations then in terms of the physical location of the bidders, and even if a telephone call or the like was used to offer remote access to an auction session to registered bidders, there are time zone limitations which limit the ability of bidders in alternate time zones to easily attend the auction. An auction method which remove these geographic and time based limitations would, it is believed, be well received.

Online sales and auctions methods have proliferated for the sales of many types of assets over the last number of years. Varying approaches and systems have been conceived for use in the sale of many different kinds of assets including those that would involve reasonably complicated sales processes including real estate. Real estate sales however offer or provide a unique set of complications that could, if addressed appropriately in an online sales method, allow for additional flexibility and it is believed would be reasonably widely accepted in the marketplace. For example, some previous methods do not require any prior identification or verification of users who could place bids—bidders might be allowed to participate in the process who have not been either tested for compliance with legal requirements or who otherwise may not have been verified from the perspective of their bona fides or ability to pay etc. Other methods, attempting to deal with this lack of verification or identification, require that the seller personally authorize or approve the participation in particular registered bidders in the process which might unduly limit the number of bidders who were able to participate. Finding a way to address the need for previous qualification or identification of bidders in an online auction method, while minimizing the need for manual intervention either by the seller or a system operator, would enhance the commercial applicability and palatability of online real estate auctions.

Auctions of high value items are also problematic from the perspective of buyers and sellers wishing to get the highest and lowest value on an auction lot, respectively. Sellers of real property or other such items will be far more concerned than an auction vendor of lower volume items, to ensure that the seller price for their items in auction is maximized. Bidders want the lowest possible price.

In auctions with few bidders or little bidding activity, pricing of the auction lots is not as easily maximized. Bidding sessions with enhanced bidding activity are most desirable. Many different types of selected bidding method have been developed to create the most excitement in an auction. An online auction method that used a selected bidding method which maximized bidding activity would be considered most desireable by vendors of high value items using online auction formats.

Negotiated sales of a property between a single potential purchasor and a seller may remain beneficial in some cases as well—for example when only a single bidder in an auction session wishes to participate in the potential sale of the property. In a case where only a single bidder wished to bid, but was interested in negotiating on a purchase, a typical auction process requiring counterbids to negotiate the sell price upwards would not work since there would not be counter bidding activity to rely on for this purpose. In such a case if there was a method by which an online auction method could effectively roll over into a two way negotiated sale process this would be considered beneficial.

An online auction system which did not require real-time participation by bidders, which provided security for sellers by way of verification or other indication of the bona fides of bidders participating in the auction, and which enhanced or maximized bidding activity within an auction would be an enhancement over the current state of the art in this area.

### SUMMARY OF THE INVENTION

The invention is an enhanced method of conducting an enhanced electronic auction, Which is intended to overcome limitations in the current art. The method of the present invention provides an enhanced online sales method in which the potential financial returns to sellers of real property or other high-value items can be maximized, allowing for flexibility in terms of the specifics of the bid comparison or ranking methodology which is used to select the current winning bids within an auction session. The security of the sales process will also be enhanced to provide additional comfort to all parties to a transaction.

The invention, a method of conducting an enhanced electronic auction of the auction lot of the seller using a selected bidding method accomplishes its high-level objectives by requiring identity verification of both the seller and the bidders who wish to participate in the auction. The method provides an enhanced means of online auction of real estate and other high-value items in part by requiring identification and verification of bidders and sellers, as well as by allowing for two novel methods of bid ranking within the auction sessions. By requiring sellers to adhere to particular verification standards within a particular product or service category, potential registered bidders are provided with maximum comfort as to the qualifications of sellers and by extension the products and services that are listed for sale, the sellers themselves are given some assurance of a reasonably level playing field between various sellers offering similar auction lots for sale.

In addition to requiring the verification of sellers, the invention also requires the verification/identification of registered bidders. By requiring registered bidders who wish to participate in an auction in accordance with the remainder of the method of the present invention to firstly provide reasonable identification or verification particulars for their user profiles, the level of commitment of registered bidders as well as their firm identification in the context of a particular auction can be judged or adjudicated by sellers based upon the transparent display of that information, by requiring bidders to provide verification information, age or other availability restrictions on particular auctions can also be enforced.

In addition to requiring the verification of registered bidders, certain embodiments of the method of the present invention would require registered bidders to provide a security deposit in a fixed amount to participate in the bidding in a particular auction. The security deposit amount might be stipulated by the operator of the system or might be set by the seller of the configuration of a particular auction lot for sale in accordance with the remainder of the system and method. If for some reason the successful registered bidder was unable to complete the closure of a purchased in which they were the winning bidder, at least the security deposit could be forfeited to the seller and the availability of a security deposit is a significant amount provide some economic comfort for the seller on the basis that they may have to go through the auction process again as well as again establishing the bona fides of the registered bidder to participate in the auction in the first place.

In addition to the requirement for verification by both sellers and registered bidders and auctions conducted in accordance herewith, the method also provides maximum upside to sellers seeking to sell high-value items by virtue of the implementation of two novel bidding approaches, the first of which is a modified one-way auction method with the bidding window time extension, and the second is a two-way auction method, both of which are outlined following in further detail. In the context of the one-way auction method, following the placement of any current winning bid in an auction, a bidding window time extension which would be established within the parameters of the overall system or by the seller for the auction itself would be triggered, to automatically extend the closing of the auction to be at least a fixed minimum period of time following the receipt of the newly qualified current winning bid, to provide additional time for potential competition and added bidding. The bidding window time extension coupled with verification of the registered bidders and sellers in the remainder of the method provides one composite novel approach to an online auction method which is differentiated from the prior art on the basis of the closest possible simulation of in person traditional auctioneering of higher value items.

In other cases, the selected bidding method used might be a two-way auction method, rather than the one-way auction method outlined above. The two-way auction method is contemplated to comprise the establishment by the seller of a selling price ceiling in advance of the opening of the bidding window for an auction. One or more bidders participating in the auction could make bids for the purchase of the auction lot. The bid with the highest bid price would be the current winning bid. Any time during the bidding window for an auction, the seller could lower the selling price ceiling i.e. they could reduce the selling price while the bidding price was coming up. When the bid price of a current winning bid met the current selling price, the auction will close. This two-way auction method closely simulates a one-on-one two-way negotiation and adds the possibility for added bidding activity either between the seller and multiple bidders, or for a seller to continual sale dialogue with an individual bidder who might be the only bidder making bids within the session.

The method of the present invention uses an auction server—which is contemplated primarily to comprise a Web server—allowing for the creation of the necessary records in an auction database in the administration of the remainder of the method. The auction server comprises an auction database which in turn comprises at least one auction profile record containing auction parameters and a selected bidding method for the auction of the auction lot. The auction database also comprises a seller profile record corresponding to the auction profile record, containing seller details of the seller of the auction lot. In some cases the auction profile record and the seller profile record might be combined and in others they may exist in freestanding data structures within the auction database. In addition to the auction profile record and the seller profile record, the auction database also includes a plurality of bidder profile records, each of which corresponds to a registered bidder and contains verified bidder details.

The auction database would also have the capability to contain a plurality of bid records each corresponding to a bid from a registered bidder in respect of the auction.

Auction software resident on the auction server would provide the capability and user interface for the seller and registered bidders to participate in the population of records in the database as well as to place bids in an auction within an auction bidding window. The server would also include a network interface by which client devices of the plurality of registered bidders could engage in a two-way communication with the auction server.

The method would be conducted by first verifying the identification of the seller corresponding to the seller profile record. This could comprise data checking or verification of information entered to the seller profile record or could comprise the conduct of an actual third-party verification of information. The identification of each registered bidder would also similarly be verified. By verifying the identification of parties to transactions additional comfort and security is provided to all parties conducting sale transactions therein.

Auction parameters from the auction profile record can be displayed to registered bidders by the user interface of their client devices in communication with the auction server. During an auction bidding window, registered bidders are allowed to transmit bids conforming to the select the bidding method to the auction server via the user interface of at least one client device. A bid comprises a bid price and the details of the transmitted bid from seller to auction server comprise a bid transmission. When as determined from bid records in respect of the auction in the database by simply selecting the bid with the highest bid price.

When the auction server receives a bid transmission it creates a bid record in the auction database corresponding to the transmitted bid, including linking the bid record to the corresponding bidder profile record of the registered bidder making the bed, and then determines if the transmitted bid to comprises the current winning bid in the auction based on the bidding parameters in the auction profile record—if the transmitted bid is a current winning bid, the registered bidder corresponding thereto is the current winning bidder. When the auction bidding window closes, no more transmitted bids will be accepted by the auction server and the sale of the auction lot to the then current winning bidder can be finalized.

Two different model auction bidding methods are disclosed, either of which could be saved within the auction profile record as the selected bidding method. The first of these is a one-way auction method, in which the current winning being deselected as being the bid received which has the highest bid price. As new bids received the bid prices compared to the then current winning bid, and if a bit with a higher bid prices received that is the new current winning bid. At the close of the auction bidding window, the then current winning bid is the winner.

In the case of the one-way auction method, every time a new current winning bid is received and selected, a bidding window time extension is applied. Effectively this means that every time that someone makes another winning bid, there is at least a minimum amount of time provided to other bidders in which they can counter with a higher offer. Following the expiry of the auction bidding window and the last bidding window time extension if any which has been applied, the winning bid at that time is the winner and the transaction can be completed. The second type of an auction bidding method which could be used as the selected bidding method is a two-way auction method. As outlined in further detail herein that comprises allowing the seller in advance of the opening of the auction bidding window to set up seller price ceiling for the auction lot. The seller price ceiling would be the maximum price, on receipt of which the seller would immediately sell the auction lot.

Once the auction bidding window opens, registered bidders can place bids up to and including the amount of the seller price. Once a bid is received in the amount of the seller price, the auction is closed.

The difference between the one-way and two-way auction methods is that in the two-way auction method, the seller is allowed at any time during the auction bidding window to lower the seller price. This effectively allows for the seller to incite further bidding activity or to concede some amount to close the sale. I was a one-way or two-way auction method outlined herein are both considered, within the context of the overall enhanced auction method outlined herein to provide two different dependent approaches to treatment both of which are novel in the larger context.

Registered bidders within an auction bidding session or bidding window could be notified either when their bid became or was no longer the current winning bid, or if they wanted to be notified of other bidding activity to allow for maximum engagement in the process. Upon the closure of the auction bidding window, the highest registered bidder being the current winning bid would win. Auctions conducted in accordance with the method of the present invention would have as few conditions as possible attached thereto other than each auction may have a reserve bid price. Many additional options and variations on the method are outlined in further detail below.

In certain embodiments of the method, bidders could be required to bid in predetermined increments.

In addition to the method, there is also provided a description and disclosure of a server for use in conjunction with an auction database and the remainder of the method of the present invention, as well as software for operation of the server to achieve the method—both of these other approaches to the invention are also contemplated within the scope here of.

By providing an online auction method and a related system, server and software, in which vendors and sellers would both be verified in advance of the conduct of an auction, commercial reliability and the method is maximized. An online auction system which did not require real-time participation by bidders, which provided security for sellers by way of verification or other indication of the bona fides of bidders participating in the auction and/or which enhance the maximized bidding activity within an option would be an enhancement over the current state-of-the-art in this area.

The system and method of the present invention could either be used for the sale of individual auction lot by an individual seller, or multiple auction lots for sale in the one bidding window or multiple auction lots for sale even by multiple sellers could also be facilitated in accordance with the remainder of the system and method of the present invention.

### BRIEF DESCRIPTION OF THE DRAWINGS

To easily identify the discussion of any particular element or act, the most significant digit or digits in a reference number refer to the figure number in which that element is first introduced.

FIG. 1 is a flow chart outlining the steps of a prior art online auction method, for comparative purposes.

FIG. 2 is a flowchart demonstrating the steps in one embodiment of the introductory portion of the method of conducting an enhanced electronic auction of the present invention.

FIG. 3 is a flowchart demonstrating the steps in one embodiment of the introductory portion of the method of conducting an enhanced electronic auction of the present invention, including the provision of a security deposit by bidders.

FIG. 4 is another flowchart demonstrating the steps of the method of FIG. 1, demonstrating the comparison and selection of current winning bids.

FIG. 5 is a flowchart demonstrating the steps of another embodiment of the method of conducting an enhanced electronic auction outlined herein, just for the auction bidding window portion of the method—using a selected bidding method which is a two way auction.

FIG. 6 is a chart showing one sample data set for a method of conducting an enhanced electronic auction in accordance herewith, in which a two way auction method is used for bidding purposes, with the seller lowering the selling price during the auction bidding window.

FIG. 7 is a schematic diagram of the architecture of one embodiment of a system architecture in accordance with the present invention.

FIG. 8 is a schematic drawing of one embodiment of an auction server in accordance with the present invention.

FIG. 9 is a schematic drawing of one embodiment of the auction database in accordance with the present invention.

FIG. 10 is a block diagram demonstrating one embodiment of the subsystems or components of the auction software of the present invention.

FIG. 11 is a schematic drawing of one embodiment of a client device in accordance with the present invention.

FIG. 12 is a screen capture of one sample of a bid entry screen on a client device in accordance with one embodiment of the method of conducting an enhanced electronic auction outlined herein.

FIG. 13 is a screen capture of the bid entry screen of FIG. 12, showing auction parameters for the auction of the property in question.

FIG. 14 is a screen capture of another portion of the bid entry screen of FIG. 12 showing additional auction details for the property in respect of an auction.

FIG. 15 is a sample of one graph display which could be generated by the auction software in a two way bidding scenario.

### DETAILED DESCRIPTION

As outlined above, the general focus of the present invention is to provide an enhanced system and method for the online auction of real estate and other high-value assets. By verifying registered bidders in the process, and accepting a security deposit, added comfort is provided for sellers. As well, the generation of a bidding window time extension at the end of the original auction timeframe, so long as an active bid meeting reserve or other requirements is on file within the auction timeframe, is the other significant enhancement over the prior art.

Prior Art Method:

Generally speaking prior art online auction methods comprise providing a website system in which a seller can post an item for sale, potential registered bidders can access the website and view information about the items for sale, and one or more registered bidders or potential purchasers can establish a system user profile and place bids on the item for sale, roughly in accordance with a traditional first hand auction method until the bidding window closes at which time the high registered bidder is the winner of the auction and is then required to pay for the item to acquire it.

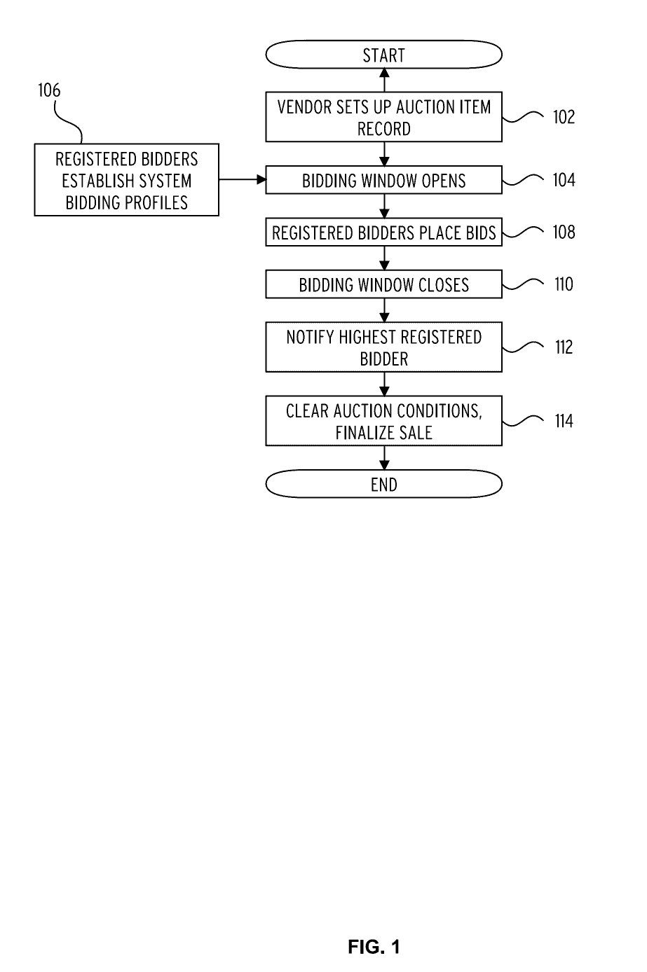

FIG. 1 is a flowchart demonstrating the basic steps of a prior art online auction method. The method which is shown in FIG. 1 would typically be accomplished using a server and website system to host the auction, and which would allow for a connection by sellers as well as registered bidders using client software to post items for sale, as well as posting bids in auctions. One example of a typical prior art online auction method would be something along the lines of the eBay™ website online auction system.

In the prior art method shown in this Figure, the first step in the process is the creation of the necessary records or information on the system for an item to be sold. This is shown at block 102. A seller would set up the necessary information, likely linked to a seller profile or other related user credentials, to allow the remainder of the method of the auction to be executed. Setting up an auction item record, as shown in block 102, would at a minimum involve entering information for display to potential registered bidders about the item or service up for sale, as well as potentially reserve price information and the like. Based on the information contained in this auction item record, the web site system can display the details of the item or service for sale, during an auction bidding window, to registered bidders who might be interested in bidding on the purchase of that product or service.

Shown next, at block 104, is the opening of the bidding window with respect to the auction item. For example it may be desired to have a 48 hour window within which a particular item was open for bids, subject to meeting a particular reserve price etc. The concept of a time bidding window in an online auction method will be understood to those skilled in the art.

Most traditional auction methods in an online setting allow for the creation of a bidding profile with basic information with respect to the user. Based upon the entry of the necessary basic profile information, the registered bidder could log on to the system and place bids on a particular product or service which is being auctioned, during a particular auction bidding window. The creation of one or more bidding profiles by potential registered bidders interested in participating in auctions in the prior art system and method shown in this Figure, is shown at block 106.

Once the bidding window in respect of a particular auction opens, shown at block 104, registered bidders who have a profile on the system can place bids in the auction. The placement of bids during the auction and the bidding window is shown at block 108. The way that most online auction methods work is basic—subject to there being a particular bid increment stipulated on the system, registered bidders who have established a bidding profile on the system can by entry of a bid amount place a bid in the auction during the open auction bidding window. The highest current bid, or in other cases all of the bid amounts received, would be displayed to users of the website system of the method, to show the current high bid or the current bid amount on the auction within the bidding window, so that a registered bidder wishing to participate in the auction would know the base amount or floor above which they must be bid to be considered the high registered bidder. The only requirement for the placement of a bid in an online auction in most embodiments such as this will be that the current bid must be higher than the last one.

At a certain fixed time, the bidding window closes. This is shown at block 110. Typically once the bidding window closes, so long as any reserve price for the item or service being auctioned has been met, the highest registered bidder is notified, shown at block 112 and declared the winner of the auction. The highest registered bidder is then required to pay the purchase amount that they bid in respect of the product or service and the sale is finalized, and the product or service delivered to the winning registered bidder. Finalization of the sale of the goods or services in this prior art auction method is shown in this Figure at block 114. There are many prior art online auction methods over which the present invention represents improvement but the method outlined in FIG. 1 is one such method shown for comparative purposes.

Bidding Window Time Extension:

One of the key differentiators of the method of the present invention over the prior art is that a bidding window time extension can be provided in certain embodiments, such that regardless of the arrival of the chronological closing of a bidding window in a particular auction, there will always be a minimum amount of time which is either system set or prescribed by the seller, for additional bids to be placed following any bid which is judged to be the current winning or leading bid in the auction.

The bidding window time extension could be defined at a system level on the system, or alternatively the system could also allow for the particular seller to set their desired bidding window time extension within the auction parameters for the auction being configured for sale in accordance with the remainder of the system and method of the present invention. In still other embodiments, without departing from the remainder of the invention, the bidding window time extension could be developed as a variable length concept—for example making the bidding window time extension longer earlier in the auction or shorter at the end, or varying its length by the bidding level in the auction etc.

The bidding window time extension effectively is a fixed mandatory minimum time following the placement of any leading bid within the bidding window. For example it might be desired to allow for a minimum period of time of four hours following the selection of any new current winning bid, within which an additional bid could be placed. The bidding window time extension would apply regardless of the arrival of the otherwise fixed chronological closing time of an auction bidding window—that is to say that in the example of a minimum bidding window time extension of four hours, if the particular auction was configured on the system to close at 6:00 PM and a high bid was placed at 5:45 PM, the closing of the auction would be extended to 9:45 PM, being four hours following the placement of the highest bid. If no additional bids were received within that timeframe the auction will close at 9:45 PM the high bid placed at 5:45 PM would be the winner. Alternatively, if another higher bid was placed at 8:20 PM, the bidding window time extension of four hours would be regenerated and the closing of the auction would be extended to 12:20 AM.

By allowing for the potential continual extension of the closing of the auction bidding window so long as bidding activity is continuing, the price of the auction lot can be driven up if there is interest and continued bidding activity, not only by virtue of the placement of a particular bid which was adjudicated to be the current winning bid at the time of the system as the otherwise chronological closure of the auction bidding window would arrive, but this would also to a degree eliminate the practice of “bid sniping” in online auctions—bid sniping is the practice of either manually or with the assistance of software tools placing a nominally higher bid right as the auction bidding window closes in an online auction, in an effort to pay only the bare minimum necessary to capture the highest bid qualification in an auction and literally by placing such a bid down to the timing of less than a second left in the auction. By implementation of the bidding window time extension of the present invention, any current winning bid which is placed at any time before the closure of the auction bidding window could trigger the generation of a bidding window time extension and the extension of the auction for a period of time within which other registered bidders interested in participating, and otherwise qualified or accredited in accordance with the remainder of the method, are able to place additional bids as well.

The combination of the bidding window time extension outlined herein, along with the verification of the identity of sellers and registered bidders outlined below, is considered to comprise the core of the subject matter of certain embodiments of the present invention. The two way auction method outlined herein, by which a one way auction can effectively be converted to a two way negotiation method is also contemplated to comprise another embodiment of the verified parties auction method outlined.

Method Overview:

One of the key shortcomings in prior art online auction methods insofar as they might be used to auction real estate and other high-value assets is the inability to maximize profit to the seller by allowing for placement of a final bid in the auction, when an auction terminates at a predetermined time. Most online auctions would have a predetermined closing time and at that point in time the highest satisfactory bid on file would be the winning bid. This is unlike an in person traditional auction, where the auctioneer and staff can oftentimes coax one or more additional bids out of interested registered bidders in the auction at the close of the bidding. If it were possible for any interested registered bidder to see the current bid level in the auction as the auction timeframe was closing, and they were significantly interested in the purchase, they might be prepared to make an additional bid which would drive up the sale price of the asset and the profitability of the auction for the seller.

The method of the present invention accommodates this type of a traditional auction approach in an online format, by providing for the optional extension of the auction bidding window in an auction, even as the fixed timeframe for the closing of the auction bidding window should approach. The system of the present invention would allow for the automatic extension by a predetermined window of additional time, referred to as a bidding window time extension, each time that a new current winning bid was determined in the auction. The length of time to be provided could be adjustable by the seller or might be preprogrammed on the system—in any event, the method provides a fixed and minimum amount of time for registered bidders to see the current bidding level in the auction and to make another bid.

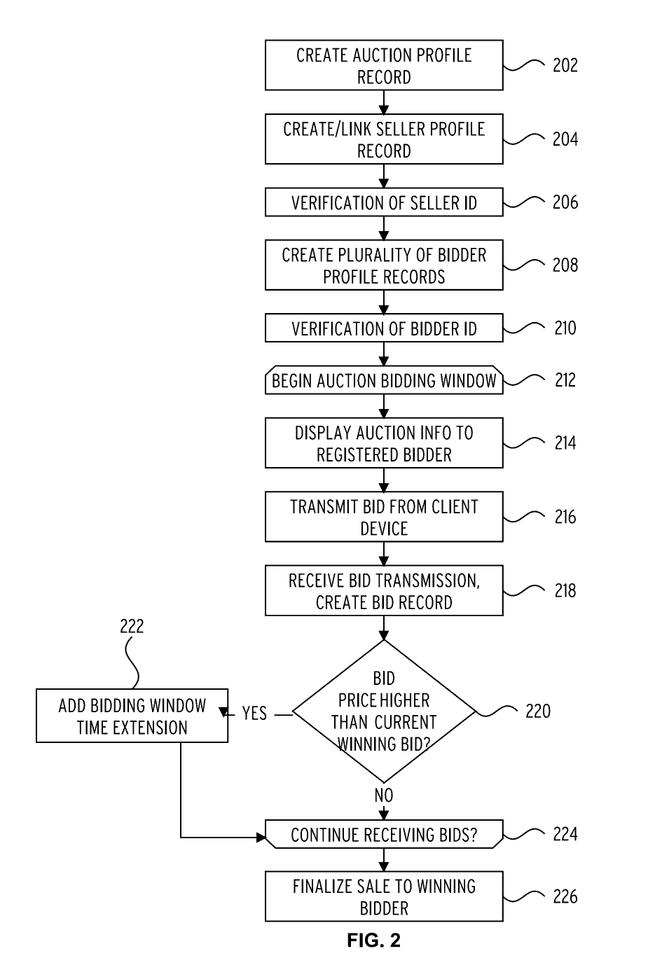

FIG. 2 is a flowchart showing the basic steps of one embodiment of the method of the present invention. As outlined above, the method of the present invention is a method of conducting an enhanced electronic auction in which both buyers and sellers are authenticated or verified in varying ways to participate in an auction, and the auction process itself provides for the inclusion of either a bidding window time extension within which additional bids can be placed in auction, after every time that a current winning bid is received or for the use of a two way bidding method between seller and registered bidders.

In the execution of the method outlined in FIG. 2, the first step shown is the creation of an auction profile record within the auction database.—block 202. The auction profile record is a record in the auction database which contains any necessary parameters regarding the auction of a particular auction lot and might include details of the auction lot itself as well as other auction parameters such as reserve price, specified length of auction bidding window and the like. Any information required either for display to registered bidders in review of the auction lot or might otherwise be required by the auction software to execute the method could be within the scope of the auction parameters stored in the auction profile record with respect to a particular auction.

The bidding parameters would include a reserve price, in cases where there was a reserve price floor in a particular auction, permissible bidding increments if that were a parameter that was desired to impose upon a particular auction, as well as the start and finishing time defining an auction bidding window in respect of the auction itself. It is typical that an auction in an online context takes place from a start time to an end time, defining a pre-defined time increment or bidding window and subject to the bidding window time extension which will be described in further detail below, it is contemplated that there would be a bidding window defined by the definition of a start time and/or a end time or bidding timeframe in respect of each auction record 40 which was created in the auction database.

Again using the example of real estate sales, an auction profile record would be created corresponding to the property to be sold and the parameters of the auction to be conducted. One or more auction profile records could be created by a single seller, for the purpose of administering more than one auction in accordance with the remainder of the method of the present invention. As will be understood to those skilled in the art of web system and auction database design, by the use of a properly configured relational auction database at the center of the system of the present invention, more than one auction of more than one auction lot could be administered at the same time by the system, and it is specifically understood that a plurality of auction profile records each comprising information pertaining to a separate auction could be resident in the auction database at the same time and could relate to the conduct of multiple auctions at the same time in accordance with the remainder of the method of the present invention.

The claims and method outlined herein pertain to a single online auction of a single auction lot, but it will be understood by those skilled in the art of e-commerce and auction systems and web design that a system which would allow for the execution of multiple auctions of multiple auction lots at the same time could also easily be designed without departing from the intended scope hereof and it is specifically contemplated that any such system would be within the scope hereof. Adding additional auction profile records to the auction database will be easily accomplished, along with the linking of multiple seller profile records or bidder profile records to multiple auctions will also be understood to those skilled in the art of relational auction database design.

Following the population of an auction profile record at block 202, a seller profile record would be created or linked in or from the auction database—shown at block 204. The seller profile record would include any information related to the seller which it might be desired to display to registered bidders during the process, or verification and identification details of the seller either for bidder or internal use. The contents of the seller profile record could also be integrated into the auction profile record in some embodiments of the auction database and such modification will again be understood to those skilled in the art of auction database design and such changes again are contemplated within the scope hereof.

It is desired to verify the qualifications of a seller either by some type of data validation on the information entered by the seller to populate their seller profile record or in some cases even to provide third-party verification or obtain third-party verification of the qualifications of the seller. For example third-party verification of the qualifications of the seller might include verifying that a particular seller was licensed under some particular type of a license regime or otherwise qualified in a particular way—one of the possible qualifications for sellers which could be verified in the context of a real-estate auction would be to verify that only licensed real-estate brokers or real-estate agents were able to post auction lots of sale in accordance with the remainder of the present invention. Verification of the seller based on the contents of the seller profile record is shown at block 206. Many different types of verification of seller identification or sellers themselves could take place, and whether that be simply an internal or automated data validation, testing the information entered by the seller in the population of their seller profile record, or whether it comprises a more detailed third-party verification, all such approaches are contemplated within the scope hereof. The population of a seller profile record for storage to the auction database would typically be done using a browser or client software interface through which the seller themselves could enter the necessary information to populate the seller profile record, which could then be communicated back to the auction database for the creation and storage of the seller profile record.

The creation of at least one auction profile record, each with a corresponding seller profile record, shows the steps in the order of the auction profile record being created before the seller profile record in this Figure. It will be understood by those skilled in the art of software and interface design that the auction profile record and the seller profile record could also be captured and created contemporaneously, or the seller profile record could be created before the auction profile record in some embodiments were desired to for example configure a sellers authentication on the system and then allow them to through their credentials or login to the interface thereof create multiple auction profile records at the same time.

A registered bidder who wished to participate in an auction would need to create a bidder profile record for storage to the auction database. Creation of a bidder profile record is shown at block 208—each registered bidder wishing to participate in the auction would require the setup of a bidder profile record—this could either take place before the opening of the auction bidding window, or after the opening of an auction bidding window if a new bidder came along who wanted to join an auction part way through. Thus it will be understood that the precise ordering of this step along with the related bidder verification step could actually physically take place at a different stage in the method without departing from the intended scope and direction hereof. The bidder profile record is again contemplated to be created by a registered bidder by entering one or more items of information in terms of their identification into a client software or browser interface for communication to the server and storage in the auction database. Various types of verification or testing could be conducted against that information, to ensure that either sufficient information is captured in respect of a registered bidder in the creation of their bidder profile record, in advance of allowing them to place bids in an auction in accordance with the remainder of the system of the present invention.

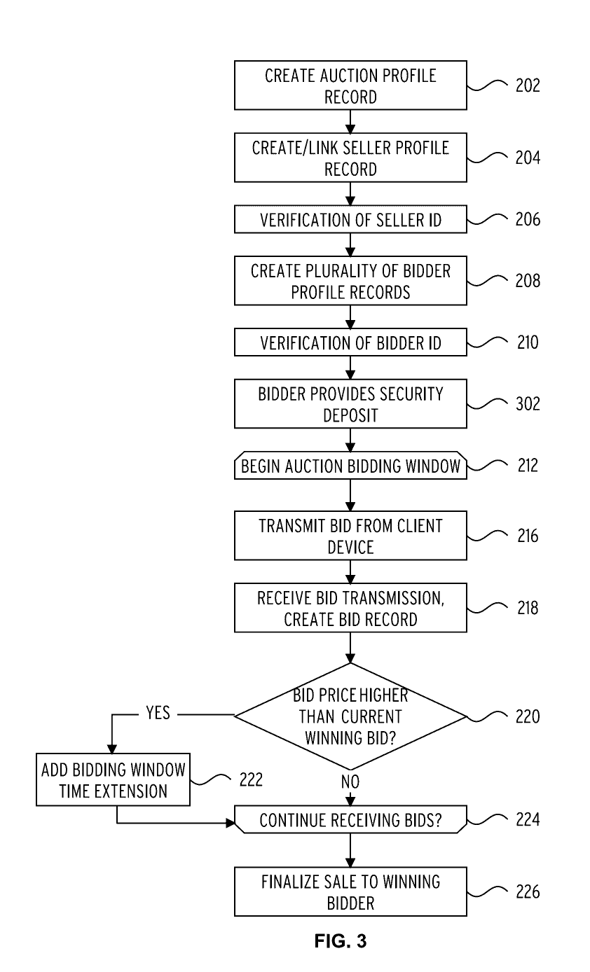

Block 208 in the flowchart shows the creation of the bidder profile record. As outlined herein, it is intended that in many embodiments of the method of the present invention a bidder wishing to participate in an auction would need to furnish a security deposit. Provision of the security deposit is shown in the embodiment of FIG. 3 at block 302. Furnishing a security deposit, as shown at block 302 in FIG. 3, along with capturing any other necessary information corresponding to the desire of a particular registered bidder corresponding to a bidder profile record to participate in a particular auction would also likely result in many embodiments in the creation of a registered bidder entry record in accordance with the remainder of the system of the present invention. The registered bidder entry record would correspond to a particular bidder profile record and a particular auction profile record, and would contain the necessary information to verify the capture or taking of a deposit from that registered bidder for entry in the auction or other information including for example parameters around the desire of that particular registered bidder to participate in proxy bidding or the like if proxy bidding was a function that was provided in accordance with the remainder of the method of the present invention.

The actual auction bidding window is shown in a loop from open auction bidding window 212 to determine close of auction bidding window 224. This loop shown in the Figure is intended to demonstrate the repeatability of the bidding process by multiple registered bidders within the auction bidding window, until the window was determined to be closed. In the case of a one-way auction method where the winning bid is the highest bid received from a bidder within a prescribed time frame, determine close of auction bidding window 224 would likely be represented by the closing of the predetermined time period within which bids could be received within the auction, subject to any bidding window time extension adjustments.

At the opening of the bidding window in the auction defined by a particular auction profile record, shown at open auction bidding window 212, registered bidders would then be allowed to place bids. Placement of bids by registered bidders is shown in this flowchart at block 216. Every time that a registered bidder placed a bid, shown at block 216, a bid record would be created within the auction database—block 218. The auction software would then test new bid records to ascertain whether a new bid which was entered was at that present time a current winning bid. The testing of that bid record 50 is shown at decision block 220

In the method of FIG. 2 or FIG. 3, if a new bid was received which was determined to at that time be the current winning bid, a bidding window time extension would be applied to the auction bidding window of the auction corresponding to the auction profile record. As outlined in further detail above, the application of a bidding window time extension, shown at block 222 in this Figure, is effectively the generation of a minimum additional period of time within which registered bidders would be able to place additional enhanced or competing bids to try to win the auction.

Based upon the capture and selection of a current winning bid, which would likely include a timestamp in the bid record along with other related serial and related information, the bidding window time extension could be applied in any case where new bid received was determined to be a current winning bid. For example if the bidding window time extension was 4 hours, every time that a new current winning bid was received within the originally defined auction bidding window, the end point of the auction bidding window would be extended to be in that case 4 hours from the receipt of the last current winning bid. This would allow for additional competition and potentially inciting additional bids to be placed in the auction. In the case that the bidding window time extension is determined to be applied, shown at block 222, the end of the auction bidding window would be extended, shown at determine close of auction bidding window 224.

On an ongoing basis a loop or test could be applied by the auction software on the auction server to determine if the auction bidding window was closed. Many different software designs could render this result of testing or leaving the auction bidding window open for the appropriate period of time originally defined in the auction profile record as may or may not be extended by the application of one or more bidding window time extensions thereto—all are contemplated within the scope of the present invention.

If the auction bidding window is closed, the current winning bidder could be notified, shown at block 226 and the sale otherwise finalized. If the auction bidding window is not complete, the auction bidding window could remain open and additional registered bidders could place bids, which each would result in the creation again of a bid record 50 with a timestamp thereon and potentially again the application of an additional bidding window time extension thereto.

If for some reason the successful registered bidder was unable to satisfy the complete payment or otherwise complete the sale of the auction lot in question corresponding to the auction profile record, if there was a security deposit having been furnished by the registered bidder to enter the auction, the deposit that they had provided in accordance with the remainder of the method of the present invention would be defaulted or paid to the seller. Alternatively the deposit would be paid to the seller regardless as a portion of the settlement proceeds in respect to the auction transaction. By the requirement that a registered bidder provide a deposit to participate in auctions run in accordance with the remainder of the system and method of the present invention, it will be encouraged for sellers to list higher-value items or auction lots for sale in accordance with the remainder of the method of the present invention.

One Way Auction Method:

In addition to the added layer of business comfort provided by the verification of sellers and bidders in the method, there are at least two types of selected bidding method which are specifically contemplated for use in conjunction with the remainder of the method. The first of these is referred to as a one way auction method. A one way auction is a traditional type of auction where multiple bidders can place bids within an auction bidding window to purchase an auction lot, and the highest bid at the time of the closure of the auction bidding window wins the purchase of the lot. As outlined herein, the concept of extending the auction bidding window by application of a bidding window time extension is used to provide maximum opportunity for incited bidding activity to maximize auction price. The current winning bid which is first selected would be the first bid received, and then subsequently the bid price of a new bid received would be compared to the bid price of the current winning bid and if the new bid had a higher bid price it would be treated as the new current winning bid. The method is contemplated to by and large remove conditions from the auction process, so the comparison of bid price is really the only comparison contemplated in most embodiments to identify the current winning bid in a one way auction, although if conditions were allowed to be included in bids those could be quantified and ranked as a part of the comparison and identification of the current winning bid. The identification of current winning bid or ultimate current winning bid in a traditional one way auction method with extensible auction bidding window, as outlined elsewhere herein, will be understood to those skilled in the art of auctioneering and any similar approach or modified approach which relies on a straight or formulaic comparison of bids received, where bids are received only from bidders and presumably only valued or permitted as they appreciate in value, are all contemplated within the scope of the present invention.

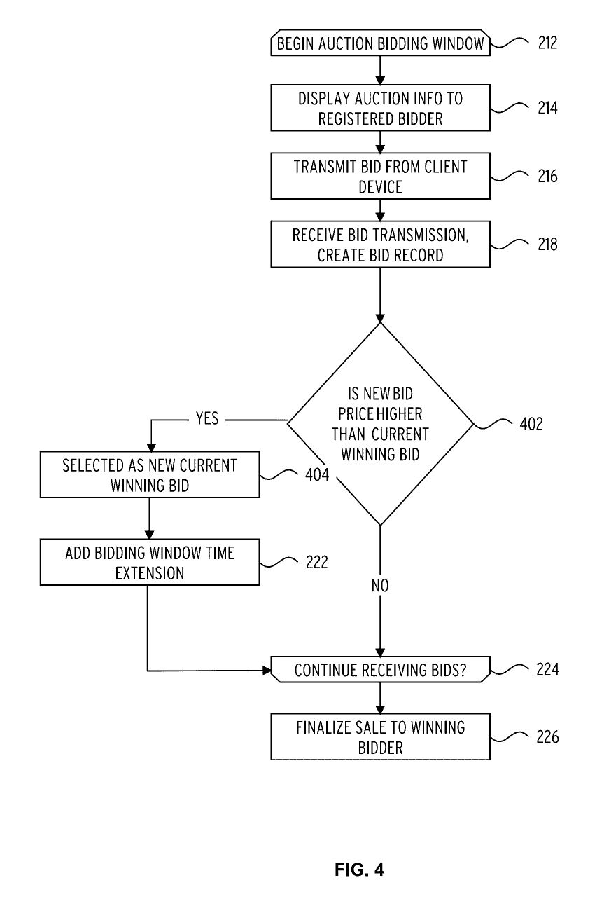

FIG. 4 shows the one way auction method applied to bids received—as shown, at decision block 402 the bid price of a new bid received is compared to the bid price of the current winning bid. If the bid price of the new bid received is higher, that new bid received becomes the new current winning bid and the bidding window time extension is added to the end of the auction bidding window. The auction bidding window continues until prematurely stopped by the system or the seller, or until the auction bidding window expires without the receipt of a newer current winning bid.

Two Way Auction Method:

The second type of a selected bidding method which is contemplated is the use of a two way bidding method, in which in addition to allow bidders to make progressively higher bids to purchase also permits the seller to adjust the selling price downward during the auction bidding window to incite or finalize a sale. If the auction profile record for a particular auction of an auction lot in accordance with the invention indicates a selected bidding method corresponding to a two way auction, this is contemplated to operate as follows:
1. A seller price is designated in respect of the corresponding auction profile record before the start of the auction bidding window;
2. During the auction bidding window, registered bidders place bids as otherwise, through a client interface—the current winning bid is selected based upon a straight comparison of the respective bid price for bids received—at any time the current winning bid is the bid with the highest bid price;
3. At any time during the auction bidding window, the seller can adjust the seller price downwards;
4. The auction bidding window closes and the auction is complete when the current winning bid bid price meets the current seller price.

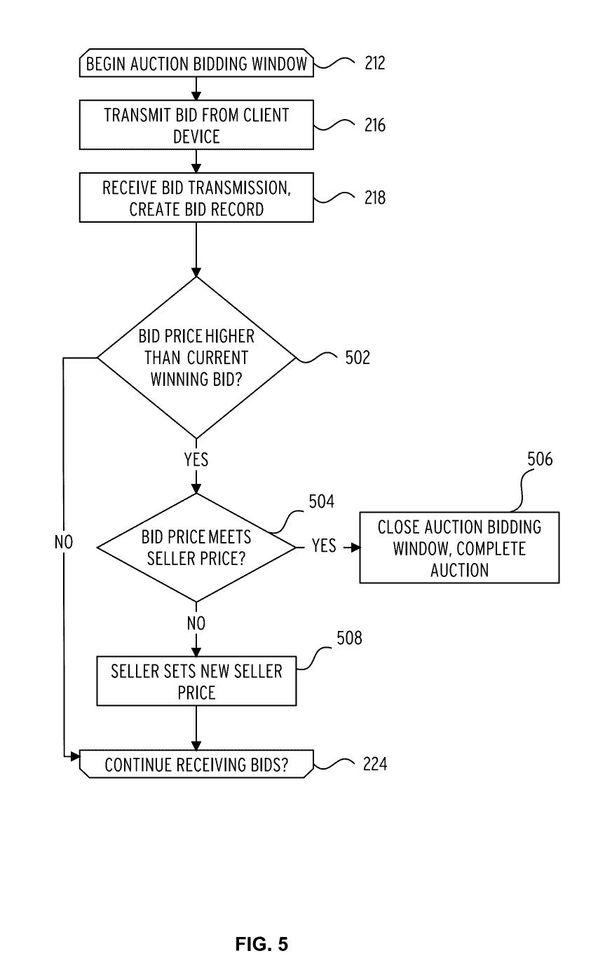

The scoring or bid comparison approach of this embodiment is shown in FIG. 5. When a bid transmission is received by the server block 218, the bid price of the new bid received is first compared to the current winning bid. If the bid price of the new bid received is higher than the current winning bid the first comparator is satisfied and the next item for comparison is to determine whether the bid price of the current winning bid meets the current seller price. If so, the auction closes and a winner is declared. If not, the bidding can continue—the seller can set a new seller price lower than the last at any time during the auction bidding window.

It is contemplated that the seller in some embodiments of the method could have the ability to accept the current winning bid at any time and close the auction early. As outlined below there are other modifications which could also be made to the method which would allow for different enhancements or bid qualification approaches to take place (i.e bidders could be required to bid in a particular bidding increment etc.)—all of these bidding parameters and auction parameters could be stored in respect of the auction profile record of the auction in question.

The two way auction method outlined allows for the conversion of a traditional auction into a parties-direct negotiation approach, insofar as one or more bidders could engage in a focused bidding session in an auction and the seller could counter offer by adjusting their selling price downwards.

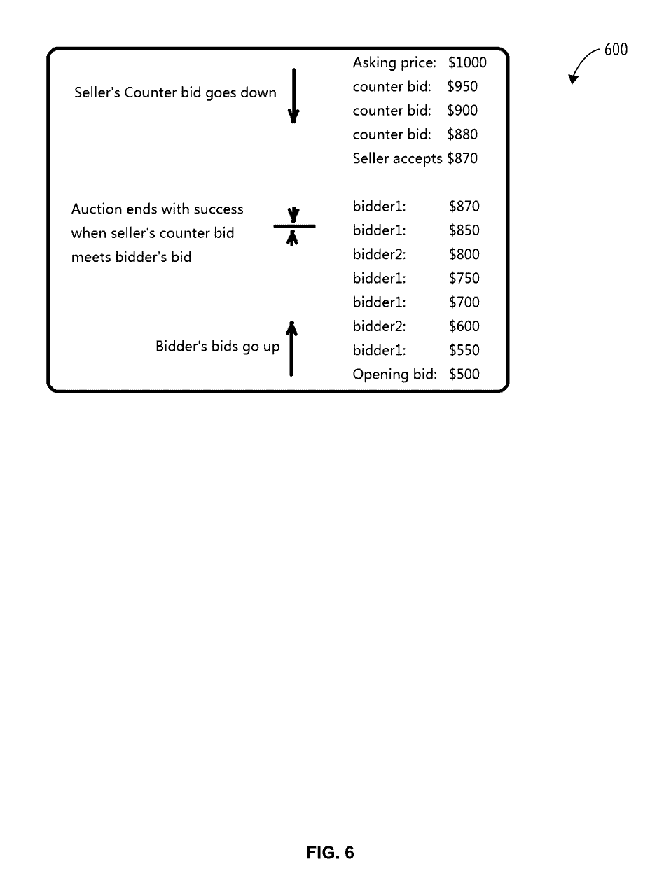

FIG. 6 shows a sample data set in an auction in accordance with the present invention, in which the two way auction method of bid assessment and counter is used. The sellers price in the auction is indicated on this chart by reference to the sellers counter bid or to the asking price—the asking price is the opening seller price, specifically it can be seen that at the opening of the auction bidding window, the seller price for the particular auction lot in question is set at $1000. The opening bid received from a bidder, which becomes the first current winning bid, was $500. The chart shows a total of eight bids made by registered bidders, coming up to a final bid of $870. The chart also shows that the seller has revised the selling price downwards in the course of the auction four times to $870. When the selling price and the bid price of the current winning bid meet, the auction is closed.

Basically the two-way auction method allows for the use of a two-way negotiation approach, in addition to a traditional auction, either where more than one bidder is interested in the property but the seller wants to incite bidding activity within the session by lowering the selling price, or in certain cases the seller may also want to enter into more of a one-on-one negotiation if there is only one bidder participating in the session.

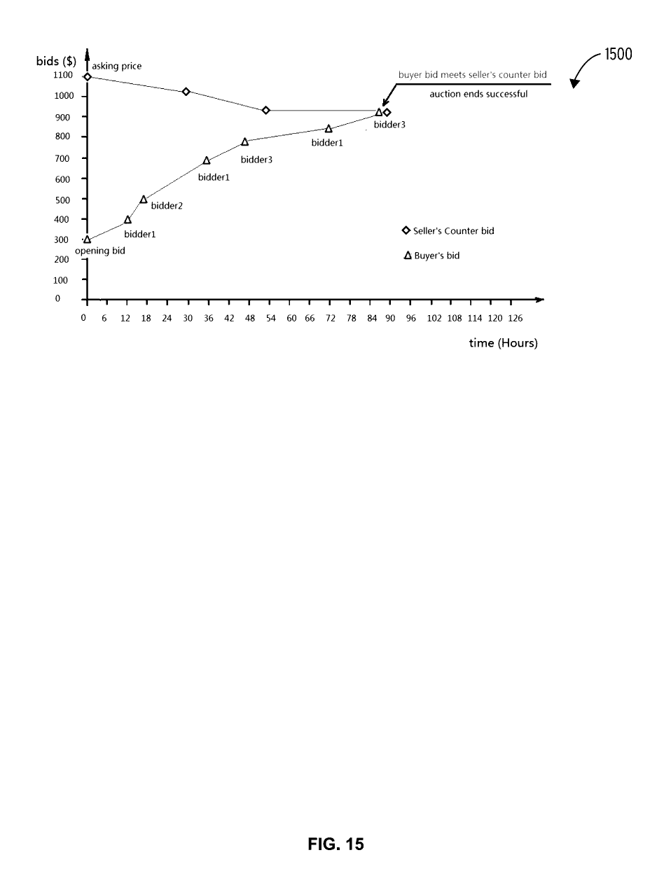

It is specifically contemplated that there would be transparency in the bidding process whereby the seller and any participating bidders could see all the details of bidding activity going on in the auction. People skilled in the art of software interface design and database reporting etc. will easily be capable of developing forms or views which could show the contents of bid records from the auction database to verified and authenticated participants within an auction. It is also contemplated that in certain embodiments of the software of the present invention, the auction software 4 in addition to displaying to a user either the most recent current winning bid, or even a listing of current winning bids received within the auction bidding window, could also alternatively provide graphic display output which would graphically display on a timeline or otherwise the details of the bids received and validated within the auction session. It is specifically contemplated that the serving of graphic output such as this would be particularly useful and interesting to users in an auction which used the two-way auction method outlined, since by plotting both the selling price as well as the bid price of qualified and winning bids received, the two lines on the graph can be seen to be approaching each other as the bidding and counteroffer activity approaches each other, and it is believed that that would further insight more bidding activity within the auction session and potentially help the seller to again at least within the ceiling established by the seller price maximize the cost received in respect of the auction lot. FIG. 15 Shows one sample of a screenshot or graphic output which plots a series of bids and counteroffers in a particular auction session.

It will be understood that the sample graphic output demonstrated in FIG. 15 is intended to only be demonstrative of the type of data points and graphic output which could be rendered—it will be understood that to those skilled in the art of statistics or mathematical analysis and its visual representation there could be all types of valuable dashboards or metrics which could be created for display to either the seller or to registered bidders within an auction, and any such output is contemplated within the scope of the present invention. The graphic output such as is shown in this Figure could also be used in a historical context, to look at the type of bidding activity which took place in respect of a particular auction lot for the purpose of analysis of bidding on a particular property or in a particular neighbourhood or area in the case of real estate sales etc.

System Architecture:

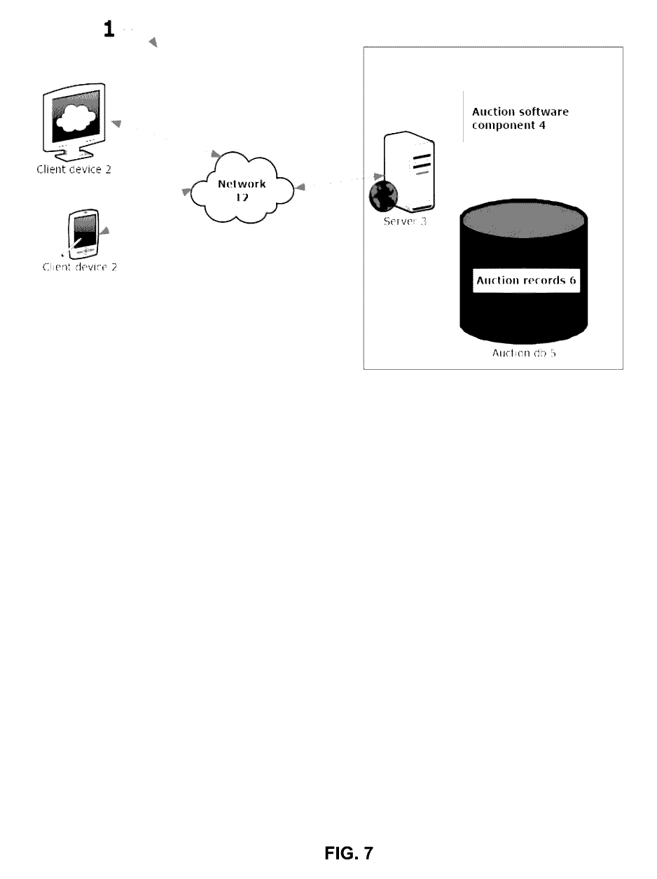

FIG. 7 shows an illustrative architecture of an overall system 1 of the present invention, in which auction registered bidders can use client devices 2, interacting with an auction server 3, to place bids in auctions. The auction server 3 might include various software applications to manage aspects of interaction between various components of the system 1, the auction server 3 or the client devices 2. Software applications on the auction server 3 would include auction software 4, responsible for the administration and handling of the method of the present invention. The auction server 3 would also host or connect to an auction database 5, which was accessible to the software applications thereon and which would comprise a plurality of records corresponding to auctions and properties being sold in accordance with the method of the present invention. The auction database 5 is shown for demonstrative purposes.

The client devices 2 would be connected to the auction server 3 via a network 8. The network 8 could be any type of a communications network capable of communication between the auction server 3 and the client devices 2. It could be a wide area network, local area network or otherwise. The client devices 2 might be statically connected so they had constantly open communications with the auction server 3, or in some embodiments of the system and method of the present invention the client devices might only periodically or intermittently initiate communication sessions with the auction server 3 for registered bidders to use them to place or monitor bidding. For example, if network 8 were wireless and it was desired to allow for the sales or placement of bids on an ongoing basis even when wireless communication was not available to the client devices 2, the system 1 could allow for periodic handshaking and communication between the client devices 2 and the auction server 3 for the sake of monitoring and placement of bids in auctions in accordance with the remainder of the present invention. The network 8 might be any combination of multiple different types of networks, such as cable networks, local area networks, personal area networks, wide area networks, the Internet, wireless networks, ad hoc networks and mesh networks or the like.

The auction server 3 might house or otherwise connect to one or more data stores of various information which are required for the operation of the method of the present invention. Specifically, the embodiment demonstrated in FIG. 7 shows an auction database 5 which is operatively connected and accessible thereto with any number of subsets of data files stored therein. Different types of data structures which will each accomplish the same overarching method of the present invention will be obvious to those skilled in the art of auction database design and are all contemplated within the scope hereof. The architecture shown in FIG. 7 shows the auction server 3 along with 2 client devices 2. Also shown is the network 8. These components are shown purely for demonstrative purposes and it will be understood that many different types of network architectures or system components and setups could be developed which would still accomplish the method outlined herein and all are contemplated within the scope of the present invention.

In operation of the system, sellers with their client devices 2 would be presented with an interface served to them from auction server 3 over the network 8 which would allow for the seller to enter auction parameters with respect to an auction lot and auction in respect of which it was desired to sell the auction lot. Following the entry of such information via the user interface on the client device 2, the entered auction parameters and their values in respect of the auction lot or the auction to be conducted would be transmitted back to the auction server 3 for storage in the auction database 5 in an auction profile record and eventual use in the administration of an auction within a timeframe to sell the auction lot in question.

Once the auction timeframe in respect of an auction lot opens, registered bidders using client devices 2 would be able to interact with the auction server 3 in the auction database 5 via the auction software 4 to place bids. Before or during the auction timeframe, in order to place a bid, a registered bidder or participant in an auction would need to identify or authenticate themselves with the system, including as outlined elsewhere herein by provision of a security deposit and the like. The auction software 4 on the auction server 3 would handle transmitted bids received by the auction server 3 for the purpose of selecting current winning bid and eventually determining the winner of the auction, regardless of the use of a one way or two way bidding method as otherwise outlined herein.

Auction Server:

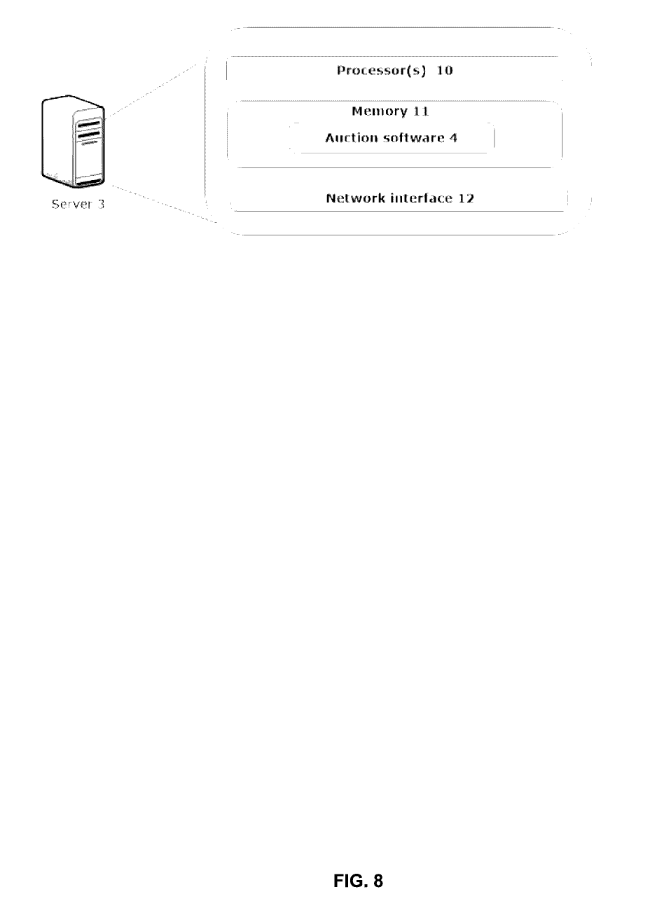

FIG. 8 outlines an illustrative embodiment of an auction server 3 in accordance with the present invention. One or more auction servers 3 might be implemented in the method of the present invention—a single server or a server farm approach. The server or servers 3 would each comprise a processor 10 and memory 11. The memory 11 might contain various software components or a series of non-transitory computer-readable storage medium for use in the method of the present invention or otherwise in the operation of the auction server 3.

The auction server 3 hosts or is operatively connected to the auction database 5. In addition to the necessary general operating system instructions and the like, the auction server 3 would comprise auction software 4 which would be responsible for execution of the method of the present invention at the server and the auction software 4 might itself act as the interface between the remainder of the hardware and software of the auction server 3 and the auction database 5, or the auction server 3 might alternatively include additional software interface instructions to the auction database 5 with which the auction software 4 and its various subroutines could communicate.

The auction server software component 4 would comprise a plurality of subroutines for the purpose of administering the auction database 5, creating and modifying auction database transactions and records in interaction with the client devices 2, as well as executing searches and reporting in certain embodiments against the auction database 5 as might be required. The details of the operation of the auction software 4 are outline elsewhere herein.

Also shown in this Figure is a network interface 12 which would be the necessary hardware and software components resident on or installed upon the auction server 3 which would allow the auction server 3 to communicate with the client devices 2 as well as any other components in the method of the present invention. The network interface 12 could again be any wired or wireless interface using a network protocol allowing the auction server 3 to communicate with the client devices 2 over a wide or local area.

Auction Database:

A central auction database 5 contains records which pertain to individual auctions being conducted in accordance with the present invention. The auction database 5 might be resident on the auction server 3, or might alternatively be resident on or administered remotely within some type of a server from an auction database environment which was operatively connected for communication to the auction server 3. The auction database 5 might also comprise multiple databases or files rather than a single file or data structure. It is specifically contemplated that the auction database 5 would most likely comprise an SQL auction database running on the necessary auction database server platform, however other approaches and tools or development environments could also be used.

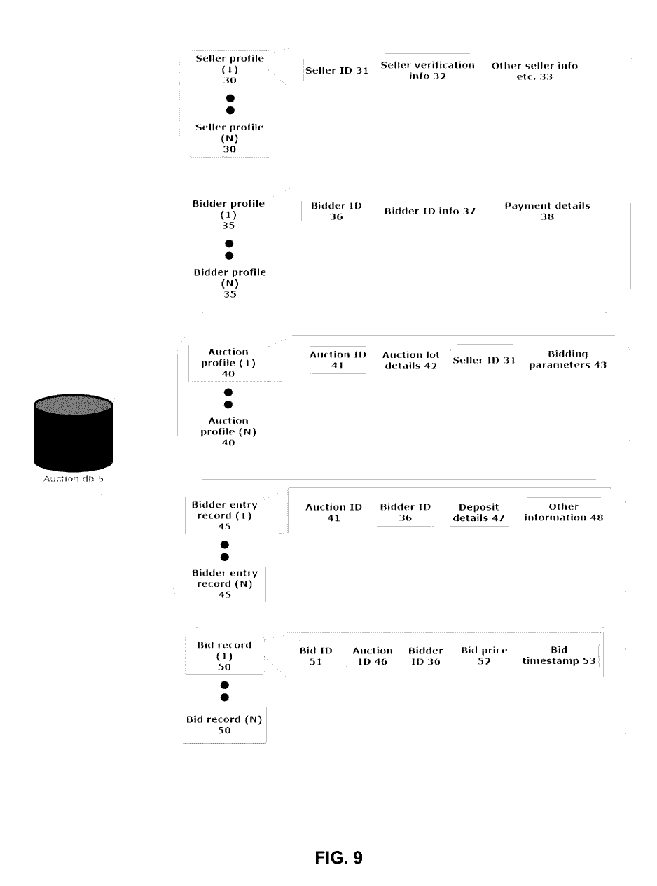

One illustrative embodiment of the data structure of an auction database 5 is shown in FIG. 9. There are five datasets shown, being a set of seller profile records 30, a set of bidder profile records 35, a set of auction profile records 40, a set of registered bidder entry records 45 and a set of bid records 50. The auction database 5 shown is an embodiment intended for use in a case where multiple auctions were coordinated by a single system, and multiple registered bidders might wish upon verification to participate in one or more auctions.

As outlined above, one of the key aspects of the method of the present invention is that sellers would verify their identity and parameters or qualifications to the system of the present invention for display to other sellers or registered bidders on the system platform. For example in the case of the sale of real estate auction lots it is specifically contemplated that in order to be a seller who could post an auction lot, it might be required that a seller be a registered real estate agent or broker. It might be required then at a minimum for the seller to provide details of their licensing or qualification this regard to complete their profile as a seller on the system and allow them to post auction lots for sale. More elaborate implementations of the system may include a more detailed verification procedure whereby the operator of the system of the present invention would actually provide third-party verification of the qualifications of the seller to list items for sale. Both such approaches, namely requiring the validation of the entry of verification or identification details by a seller which would simply be tested by the software on the system for its completeness, or a system which would include some degree of third-party verification of the qualifications or verification details of the seller which were entered by the seller in establishing their seller profile on the system are both contemplated within the scope of the present invention.

The seller profile records 30 in the auction database 5 shown in this Figure would each correspond to a particular seller who wished to post at least one auction lot for sale in accordance with the system of the present invention. As shown in this Figure, each seller profile record 30 would at a minimum contain a seller ID 31 which would be a database key. The seller would also enter various seller verification information 32 into the system which would be information related to the verification of the qualifications of the seller to participate in one or more categories of auctions on the platform of the present invention. For example seller verification information 32 might include license parameters in terms of licensed brokers or agents or the like.

Other seller information 33 could also be captured within one or more of the seller profile records 30. This might include additional information to be displayed to users of the system viewing particular auction profiles or other information displayed on their client software, or may include authentication credentials or the like for the login of the seller to the web site system of the present invention.

The auction database 5 would contain a plurality of seller profile records 30, each seller profile record 30 containing the identity information provided by a seller which could be displayed to registered bidders or within the context of the administration of auctions of the system. The seller profile record 30 in respect of a seller would contain all the necessary information to conduct any desired verification of the identity of the seller as well as to allow for the seller to participate in the listing of auction lots for sale of the system. A seller in their seller profile record 30 might include their desired default settings in terms of a bidding window time extension, for application to every option of auction lot listed by that seller for sale. A seller profile record 30 might also include payment details by which either defaulted security deposits or payment for successful auctions could be rendered to the seller upon completion of the auction of an auction lot. Any number of different types of information pertaining to sellers listing items for sale within the context of the system and method of the present invention could be contained within a seller profile record 30.

The second data subset in the auction database 5 which is shown in this Figure is a plurality of bidder profile records 35. The bidder profile records 35 each correspond to a registered bidder wishing to bid in one or more auctions being administered in accordance with the system and method of the present invention. A bidder profile record 35 would include a database key 36 along with other registered bidder identification information 37 which would be captured for the purpose of providing transparency and identification of the registered bidder to users of the system, including sellers who would be potentially selling their products or services to registered bidders in auctions. The bidder profile record 35 might also include payment details 38 which could be banking wire transfer information, credit card details or the like, for the furnishing of security deposits in respect of auctions or even for the purpose of processing the remainder of payment on a successful auction bid to be placed by the registered bidder in an auction.

In order to participate as a registered bidder in the auction of an auction block in accordance with the remainder of the present invention, a registered bidder would need to establish a bidder profile record 35 in the auction database 5. As in the case of the seller profile record 30, the bidder profile record 35 would contain all the necessary identification and verification information with respect to particular registered bidder to allow for the fulfillment of the required aspects of the method of the present invention including the verification of the identification of the registered bidder, the acceptance of the security deposit in respect of a particular auction, and the necessary credentials or other parameters with respect to the registered bidder to allow the registered bidder to participate in one or more auctions in accordance with the present invention.

For each auction lot which was desired to auction in accordance with the present invention there would be an auction profile record 40 created within the auction profile record 40 subset of the auction database 5. Each auction profile record would include an auction database key or an auction identifier 41 as well as details of the auction lot itself 42 which might be desired to be displayed to potential registered bidders for the purpose of informing them as to what they are bidding on and inspection information, qualitative or quantitative assessment information or any other details that it might be desired to provide to registered bidders to give them information and solicit their bids in an auction of the particular auction lot in question. The auction profile record 40 would likely also be linked to the seller profile record 30 of the seller who had created it.

Various parameters around an auction to be conducted in accordance with the present invention would need to be captured in the configuration of an auction profile record 40 related to that auction. That could include basic identifying information of the auction lot to be sold, along with the identification of the seller—likely by linking the auction profile record 40 in question to a seller profile record 30 in the auction database 5. In addition to basic identifying information of the auction lot, photos, additional information, certification reports, or any manner of other information which could be stored in different types of data structures in an auction database could be uploaded to the system for display to registered bidders to provide them with information and engage their interest in participation in the auction of the auction lot in question.

In addition to identifying the auction lot, the auction profile record 40 would also have to contain integrally or in a related and linked data structure additional parameters for the administration of the auction itself. For example, if there was a particular time when the auction bidding window was to open, that time could be entered into a field in the auction profile record 40 so that the website system of the present invention could automatically open the auction bidding window at the appropriate and desired time. It is also specifically contemplated that auctions to be conducted in accordance with the present invention, subject to the application of the bidding window time extension concept outlined herein, would be set to run for a predetermined chronological time or bidding window. For example it might be desired that a particular auction will remain open for 72 hours—if a start time for the auction was also entered into the auction profile record 40 along with the desired bidding window length, the system could automatically open the bidding window at the appropriate time and close the bidding window at the appropriate time, at the closure of the desired 72 hour bidding window, subject to the application of any bidding window time extension.

Certain embodiments of the system of the present invention might have a hard coded chronological bidding window therein such that every auction posted in accordance with the remainder of the system and method would be run for the same predetermined length of time. Alternatively, the user of the system could be allowed to specify the bidding window length when they set up the remainder of the auction profile record—that is more likely the more desirable approach but either approach to the establishment and maintenance of the profile and the related bidding window for an auction of an auction lot herein is contemplated within the scope of the present invention.

Certain embodiments of the method might incorporate additional auction options or notifications which might require the capture or storage of additional auction parameters in or in relation to the related auction profile record 40. For example some embodiments may include proxy bidding. If proxy bidding or automatic bid increments were implemented in certain embodiments of the system or if the seller wished to permit proxy bidding in a particular auction they could enable that or provide the necessary additional parameters in that regard

As well, if there was a “buy it now” price or option to be permitted with respect to a particular auction or auction lot, the details of that would be stored as additional parameters in respect of the auction profile record 40 as well. Any information which was desired or necessarily captured for the proper operation of those functions would be stored as auction parameters in relation to the auction profile record in question and all such captures, programming modifications or the like as will be obvious to those skilled in the art of auction methodology and related programming are contemplated within the scope of the present invention.

A registered bidder entry record 45 could be created each time that a registered bidder, who already had created a valid bidder profile record 35, wished to enter into bidding in a particular auction corresponding to an auction profile record 40. Registered bidders could participate in more than one auction but for each auction in which they wished to participate the registered bidders may need to provide various bidding information or parameters and/or deposit details. Shown in the plurality of registered bidder entry records 45 in this Figure is an auction identifier 41 which corresponds to an auction profile record 40. There also is shown a registered bidder ID 36 which corresponds to a bidder profile record 35. Basically the registered bidder entry record 45 pairs a particular registered bidder with a particular auction, and a bidder profile record 35 with an auction profile record 40.

In respect of a particular auction profile record 40 there might be a required security deposit for that auction, stored within the bidding parameters 43, in which case it would be necessary for the registered bidder who was the subject of the bidder profile record 35 to provide that security deposit in order to enter bids into the auction. The deposit details 47 could be included in a registered bidder entry record 45—they could also be included in some other type of a data structure as will be understood to those skilled in the art of any such approaches contemplated within the scope hereof. Finally, shown as other information 48 would be the other parameters of a particular registered bidder's participation in a particular auction—for example if one or more auctions on the system or platform of the present invention were to be conducted including a proxy bidding mechanism and the registered bidder wished to participate in proxy bidding their proxy bidding parameters or other similar items could be included within the registered bidder entry record 45.

The system and method of the present invention could include the necessary software or hardware components to process and accept security deposits from registered bidders as well in respect to particular auctions in respect of which they wanted to participate. This could be done by the provision of a credit card processing facility within the software resident on the auction server 3 or by other payment processing or payment acceptance methods—any type of system modification or enhancement which allowed for the processing or acceptance of monetary security deposits in respect of options to be conducted, and in respect of an individual registered bidders bidder profile record 35, are contemplated within the scope of the present invention.

Finally auction database 5 includes a plurality of bid records 50 each corresponding to a bid placed by a registered bidder in a particular auction. Each bid placed in an auction would be the subject of a bid record 50 in the auction database—the bid ID 51 is shown, along with an auction identifier 46 and a registered bidder identifier 36 which correspond to a bidder profile record 35 and an auction profile record 40. Also included in each bid record 50 would be a timestamp 53. The timestamp would be necessary for the purpose of calculation and application of the bidding window time extension if the bid which was the subject of a particular bid record 50 was determined to be at a particular time a leading bid in the auction. Bid records 50 could contain additional information as well.

Auction Software:

The key software element of the present invention is the auction software 4 which is contained within the software instructions resident on or accessible to the auction server 3. In practising the present invention it is specifically contemplated that the functions of the auction software application 4 would include the creation and administration of records in the auction database 5, interaction with the client devices 2 for the purpose of display of information from the auction database 5 to users of client devices 2 in the field as well as for the receipt of seller and registered bidder or auction profile information, bid details and other information for upload from client devices 2 and their users for storage to the auction database 5. There could also be a query and reporting interface either within the auction software 4 or otherwise accessible to the auction database 5. Each of these software modules could be freestanding software programs or subroutines within the memory or storage of the auction server 3, or alternatively they could each be functions in a consolidated software program and both such approaches will be understood to be within the scope of this application.

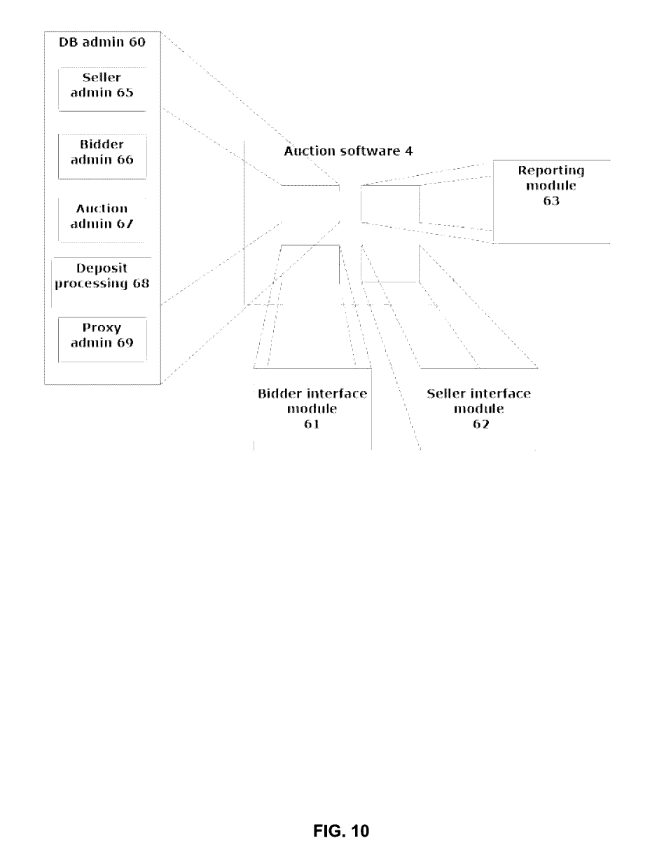

FIG. 10 shows the key components or subroutines which would be contained within the auction software 4. Overall the creation and administration of records within the auction database 5 would be conducted by an auction database administration module 60. The auction database administration module 60, through a plurality of subroutines or substructures, would be responsible for the administration of records in the various data subsets within the auction database 5. There is shown a seller administration module 65 for the creation or administration of seller profile records 30 in the auction database 5, a registered bidder administration module 66 for the creation or administration of bidder profile records 35 in the auction database 5, an auction administration module 67 for the creation and management of bid records 50 and auction profile records 40 and the like within the overall context of the remainder of the method and software component, as well as a deposit processing gateway 68 and a proxy bidding administration module 69 in the particular embodiment shown. It will be understood that the embodiments of the system and method of the present invention which did not incorporate a proxy bidding component, a proxy administration subroutine or code class 69 would not be required and in that case it will be understood that it would not be found in all iterations of the auction software 4 for all necessary embodiments of the system and method of the present invention.

The seller administration module 65 would be responsible for writing and retrieving records to and from the auction database 5 that related to seller profile records 30. This module might also work in conjunction with other software modules for the purpose of querying or reporting from the auction database 5, or for the sake of structuring user interface and interaction with the auction database 5 and the remainder of the software of the system. Similar to the seller administration module 65, it is also contemplated that there would be a registered bidder administration module 66 responsible for the creation or administration of bidder profile records 35.

There would also be an auction administration module 67 which was responsible for the creation or administration of auction profile records 40 within the auction database 5, as well as potentially for the administration of the actual auction itself in so far as that might interact with auction profile records 40 or other records within the auction database. The auction administration module 67 might also be responsible for the creation and maintenance of registered bidder entry records 45 or bid records 50 as shown in the auction database demonstrated in FIG. 5.

There is also shown a deposit processing module 68 which could either be internal software or a connection to a payment processing gateway or other necessary software to either automatically or electronically process and accept a deposit, or to alternatively accept and endorse into the bidder profile record or registered bidder entry records related to the participation of that registered bidder in the particular auction question of their deposit to the operator of the system. Either an online/virtual or electronic processing method which would allow for the automated processing and receipt of security deposits, or a system which would allow for manual processing and acceptance of deposits from registered bidders to allow them to participate in auctions and subsequently indicate or allow them to enter bids based upon the acceptance of such a deposit, are both contemplated approaches within the scope hereof.

Either within the software modules or elsewhere in computer storage accessible to the processor and memory of the auction server 3 are interactive web forms or other client content and software instructions or information which might be required for a field user being a seller or a registered bidder with a client device 2 to interact with the auction software 4 for the purpose of updating, creating or otherwise manipulating data in the auction database 5.

In addition to the overall auction database administration module 60, the processor instructions accessible to the auction server 3 in the auction software 4 would include a client interface module or modules—these are shown here as a registered bidder interface module 61 and a seller interface module 62. The interface modules 61, 62 might comprise the necessary processor instructions for the auction server 3 to interact with one or more client devices 2 via the network 8. If the client device 2 is using a locally installed client software program the interface modules 61, 62 might comprise a server to send and receive data to and from the auction database 5 to the client software on the client devices 2. Alternatively, if the system of the present invention were executed as a secure client/server website system, the interface modules 61, 62 might include the necessary software to allow in a traditional client/server website context of the interaction between a client browser on the client device 2 and auction server 3. In addition to processor instructions, the interface modules 61, 62 might also include web forms, media or other data which was required to engage and sustain a communication session with a client device 2.

Also shown is a reporting module 63. This again might be an optional software component if certain types of administrative reporting or queries were desired to drive different dashboards or displays to users of the system.

Client Device:

A client device would be used by sellers to interact with the system of the present invention for the purpose of both identifying and verifying themselves as legitimate sellers for the posting of auction lots, as well as to configure the placement of particular auction lots for sale in accordance with the remainder of the present invention. Client devices would also be used by registered bidders for the purpose of identifying and verifying themselves and placement of bids within auctions being administered in accordance with the remainder of the system of the present invention.

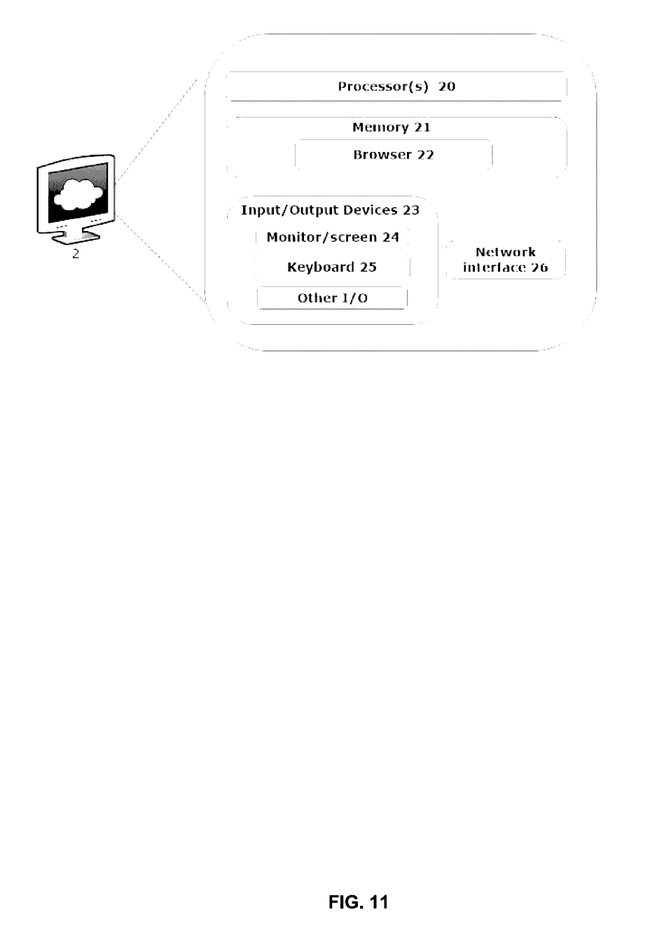

FIG. 11 is a schematic representation of one client device 2 in accordance with the present invention. The client device 2 includes one or more processors 20 and memory 21 within which multiple are various computer processor instructions might be resident or stored for the purpose of the overall operation of that client device 2. It is specifically contemplated in a circumstance where the auction server 3 is a Web server which will dynamically serve and receive content to and from browser software 22 installed upon one or more client devices 2 that the primary software interface installed on the client device 2 for use in association with the auction server 3 of the remainder of the present invention is a regular web browser software 22. Also shown is a network interface 26 which in the case of this particular device shown could be a wireless or wired Internet or telecommunications interface. Also shown a plurality of input-output devices 23, including a monitor/screen 24, keyboard 25 and the like.

Many different types of client devices 2 can be used in association with the present invention. As outlined, the key concept with respect to the types of client devices 2 which can be used in the method of the present invention is that wireless devices could be used to allow for the best streamline field entry of auction attributes or other information for communication and storage in the auction database 5 through the remainder of the system. Most desirably, the client devices 2 would be non-purpose built hardware, using pre-existing communication networks—such as tablets, smart phones or portable computers connected to data networks. Use of nonspecific hardware in this fashion would allow for the installation of additional software components for the practice of the method of the present invention on pre-existing hardware and non-purpose built hardware. Any type of a computing device which was capable of interaction with the remainder of the system the present invention and the auction server 3, as well as the remainder of its associated components via the network 8 are contemplated within the scope hereof.

More than one type or category of client device 2 could be used in the overall practice of the method of the present invention. Sellers might use a different category of client device 2 than registered bidders, or each individual user of the system be this seller or a registered bidder could use a different type of a client device.

Insofar as the method of the present invention is built around the ability of sellers and registered bidders to remotely enter, store and interact with auction information in an auction database 5, the client devices 2 used by sellers and registered bidders would need to include a software program which was capable of interacting with the remainder of the system of the present invention. This could take the form of either a freestanding proprietary client software 22, capable of communication via the network 8 with the auction server 3 of the auction database 5 resident thereon along with the various software components 4 on the auction server 3, or alternatively a web browser to authenticate to and interact with the auction server 3. Either such approach is contemplated within the scope of the present invention—the basic requirements of the client software 22 would be the need to be able to interact with the remainder of the software and hardware components resident on or connected to the client device 2 at the appropriate time to capture data entry from the operator of that device, as well as to provide for the ability to interact by way of data entry forms with the auction server 3 for the entry of auction data or be a data to the auction database 5 in respect of a particular auction lot or auction. In certain cases the client software 22 used by or accessible to the client device 2 would also provide the ability to retrieve attributes or other information from the auction database 5 accessible to the auction server 3 for display a reporting purposes, by acquiring and transmitting query information for use in the extraction of such information.

Populating the Auction Database:

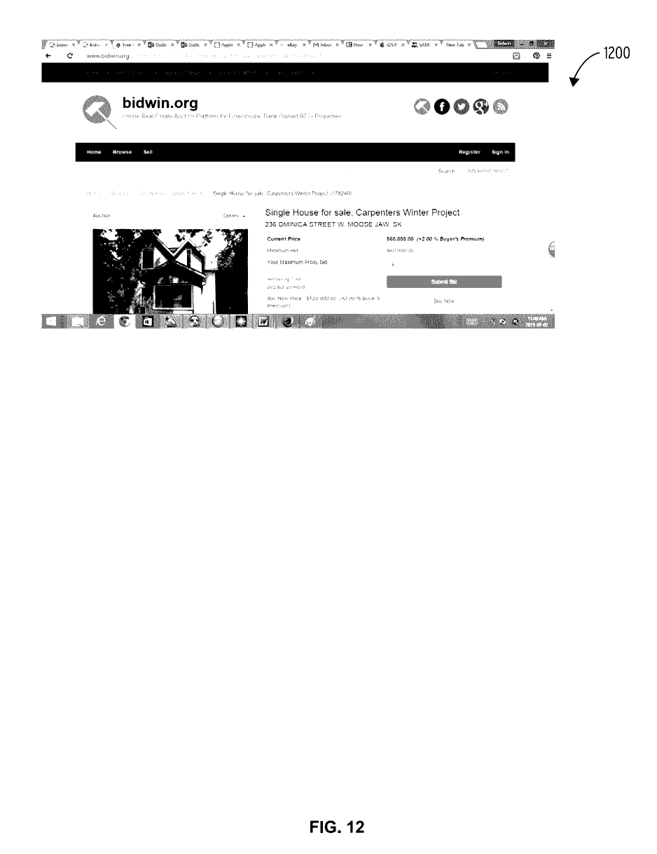

FIG. 12 through FIG. 14 are sample screenshots showing one potential set of screens which could be used in the entry of data to create records in accordance with the remainder of the method of the present invention in the auction database. For example FIG. 12 shows a bidding screen sample, which shows basic information which pertains to the auction lot being sold as well as the indication of a login or authentication area for the registered bidder, following which bids could be logged by the registered bidder in the auction within an auction window.

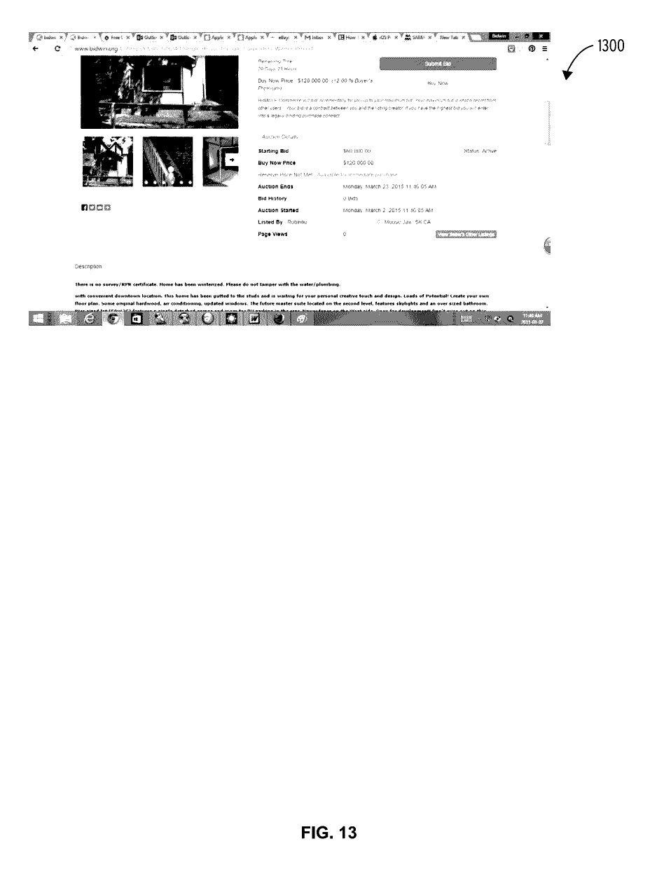

FIG. 13 shows a lower portion of the screen of FIG. 12, indicating some of the additional auction parameters which would be stored with respect to the auction profile record of the auction which would otherwise be generated or used by the system in the administration of the auction. Specifically, the start time and end time of the auction are included or shown on that screen. Upon the receipt of one or more bids above the reserve price in respect of the auction lot, the end time would be moved by the application of the bidding window time extension calculation which was desired to be applied to this particular auction session.

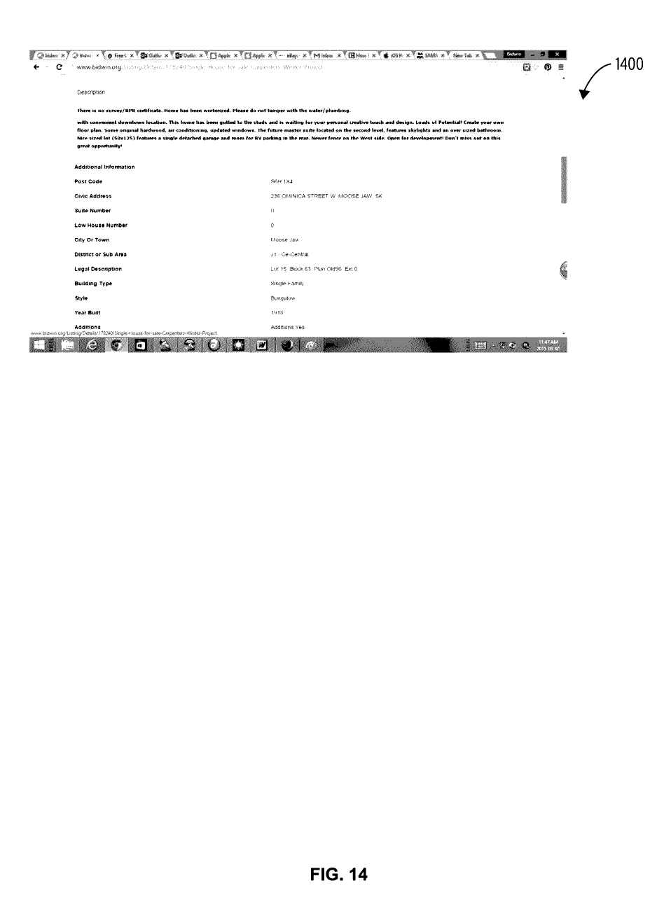

Finally FIG. 14 shows some additional auction lot detail which will be understood to be available from the auction profile record or records and data structures within the auction database and five, which is intended to provide additional information regarding either the verification or authentication of the seller as well as the details of the property for sale itself. It is specifically contemplated as outlined elsewhere herein that the method of the present invention would be highly desirable in terms of the online auction process for real estate properties. However, it will also be understood that some of the information which would be captured to an auction profile record and the remainder of the method itself could be modified to use the lexicon and approach of auctioneering of alternate types of properties or services rather than simply real property. Templating or modifying a system such as this for application to different types of auction properties will be understood by those skilled in the art.

During the auction itself of an auction lot which had an auction profile record 40 within the auction database 5, during the open bidding window, registered bidders who each had created a bidder profile record 35 and furnish the necessary verification and deposit could log into the website system provided for the purpose of viewing and participating in the auction. If they wish to place a bid in respect of a particular auction, the client/server software and system could permit through the client software on the client device of the registered bidder the entry of a bid. Upon entry of a bid at the client software on the client device of a registered bidder, and transmission of the information relating to that back to the server, a bid record 50 could be created in the auction database 5. If a bid record 50 was created in the auction database 5 which was determined by the auction software 4 to at that time be the current winning bid, the bidding window time extension calculation would be applied, using the bidding window time extension which was either set by default for programmed in specific relation to the auction of the particular auction lot. Early in the original auction bidding window, the application of the bidding window time extension calculation would not in most cases result in any extension of the end of the early or preset bidding window. Later in the preset bidding window in respect of the auction however, the application of the bidding window time extension calculation would likely result in the extension of the end time or closing time of the bidding window in respect of particular auction.

In embodiments of the system and method of the present invention in which an automatic or proxy bidding mechanism was included, the receipt of a bid on behalf of one registered bidder would also result in the examination of the current status of bid records in respect of an auction being conducted and additional proxy bids could be generated, with related bid records 50, resulting in the placement of additional bids of behalf of registered bidders who had indicated a desire to participate using a proxy bidding mechanism with some type of a bidding increment.

Bid records 50 would be generated and placed in the auction database until the closure of the bidding window at which time the highest bid, being the current winning bid, could be selected and the auction sale of the property in question finalized.

Elimination of Seller Bidding:

There are numerous variations or additional functional enhancements on the general method of the present invention which could provide additional flexibility as well as additional market acceptance of the method. One such optional enhancement which is considered to significantly enhance the acceptability of the system of the present invention from the perspective that it provides more certain auction outcomes or results would be the elimination of seller bidding. By eliminating the ability of sellers to bid in an auction on a property which they have listed for sale, the registered bidders who might be participating in the auction can be assured that there will not be manipulation of the auction by the seller. In exchange for the provision of non-conditional bids by registered bidders participating in the auction, registered bidders can be assured of the reasonable straightforward nature of the auction on the fact that they are, so long as a particular reserve price was being met, not be manipulated by the sellers participating in the auction. It may be the case that the ability of sellers to bid in auctions could be blocked out entirely by the overall system and method of the present invention, or in other cases it may be desired to provide the ability on the system for the seller to select or deselect the ability of sellers to bid in their own auctions—the transparency in this part of the process would be that potentially auctions on the platform of the president invention which indicated that sellers could not bid would potentially be commercially more attractive for competition.

Proxy Bidding:

Certain embodiments may include a proxy bidding element. Proxy bidding is a concept in auction methodology whereby a particular auction can permit placement of bids in absentia on behalf of registered bidders who wish to participate in an auction in their physical absence from the bidding session. For example a registered bidder may wish to place one or more bids in an auction in the absence of their ability to physically check their client software on their client device from time to time—typically how this would be implemented would be that a registered bidder could indicate their desired highest price they were prepared to pay using in absentia or proxy bidding, and potentially specifying a bidding increment. If a registered bidder in respect of a particular auction indicated a desire to proxy bid they could for example indicate that they were prepared to pay up to a total of $150,000 for a particular auction lot, and specify that they were prepared to bid in increments of $5000. Every time a leading bid record was created in the auction session related to another registered bidder, so long as the parameters established by this registered bidder were not exceeded i.e. they had not yet bid up to a total of $150,000, the system could generate automatically the placement of an additional bid on behalf of the proxy registered bidder in an added increment of $5000. The incorporation of proxy bidding into online auction methods will be understood by those skilled in the art and is contemplated and will be understood to be within the scope of the invention as an optional add-on for the system and approach outlined herein

No Conditions:

Another optional requirement of the system of the present invention would be to provide the auctions conducted in accordance with the remainder of the method could not be conditional in anyway. So long as a reserve price floor was met, the product or auction lot would sell without any significant additional number of conditions. Particularly in the context of selling real estate, it is desirable to provide a system whereby sellers could provide inspection information or other information on the web platform for use by registered bidders contemplating bidding in an auction, such that upon the selection of the winning bid in an auction subject only to the most basic of conditions there would be a requirement that the sale were to close and the transaction will be binding on both parties.

Early Auction Closure:

Certain embodiments of the method of the present invention might allow for a seller to trigger the early closure of auction in respect of a particular auction lot. For example if the highest or most desirable bid, or as is also known in the context of many other online auction methods a “buy it now” price or indication was reached or received from a particular registered bidder, the auction of particular auction lot could be closed either in advance of the closure of the chronological auction window or in advance of the expiry of a bidding window time extension. The necessary software modifications to implement this type of an approach, including the capture of the parameters around the addition of this functionality to the sale of a particular auction lot in the auction lot profile in respect of that lot, will be understood to those skilled in the art again of auction database and software design and are all contemplated within the scope of the present invention.

Registered Bidder Notification:

It is specifically contemplated that in accordance with the remainder of the system of the present invention, registered bidders who are participating in an auction could be provided with notification every time that their bid either was or was not any longer in position as a leading or winning bid in an auction. Every time a higher leading bid was placed if the last highest leading registered bidder was notified, or even if all registered bidders were notified, this could incite additional competitive bidding activity within the auction. It would also be desirable for a registered bidder to know when their bid was surpassed as the leading bid in an auction, since they may wish to place an additional higher bid to stay in the competition for the winning position in the auction. The physical means of implementing such a notification system will be understood to those skilled in the art of computer software and web and electronic messaging design. All such systems and software designs which would implement a real-time notification component for the notification of some or all of the registered bidders within an auction as to the status of their bids is contemplated within the scope hereof.

Real-Time Messaging:

In addition to the remaining novel functions of the method of the present invention it is also contemplated that real-time messaging would be provided in accordance with the system, wherein registered bidders could communicate in real time with sellers to ask questions or understand issues related to particular auction lots offered for sale and to otherwise generally speaking facilitate the commercial auction and bidding process. Provision of a real-time messaging component in addition to the remainder of the client/server system of the present invention will from a infrastructure development perspective be understood to those skilled in the art of auction database and website design and it will be understood that any type of a development which offered the ability to have sellers and registered bidders, or even sellers for registered bidders and the operator of the system of the present invention, to engage in real-time messaging either before, during or after the opening or closing a particular auction in accordance with the remainder of the method of the present invention are contemplated within the scope hereof.

Service Bureau:

It is specifically contemplated that the service of the present invention could be offered a service bureau format, for the offering of online auction assistance in accordance with the method of the present invention for use by multiple sellers even in multiple subject areas or for sales of multiple types of auction lots at the same time. Particularly if the service delivery method is by way of a client/server web server and web client browser approach, service bureau offering this type of service is the most likely method of delivery and is the method which is shown with respect to many of the embodiments demonstrated herein. It will also be understood that certain embodiments of the method of the present invention may rather than as a service bureau be rendered with a smaller set of templates or interactions with a group of sellers and registered bidders within a particular industry or subject area, for the sale only particular types of auction lots or even for operationally by a single seller in the operation of the system selling multiple auction lots on behalf of a single seller or group of sellers. Both such approaches are understood to be within the scope of the present invention.

It is specifically contemplated that the actual creation of auction profile records, seller profile records and registered bidder profile records as well as the entry of bids during an auction session in accordance with the remainder of the present invention could be done remotely with wireless or remote client devices, in network communication or connectivity with the server in accordance with the remainder hereof. However it will also be understood that some or all of this information could be entered either from a central service bureau or from a hard wired network terminal, or from such a wireless or remote device, and both such approaches again will be understood to be within the scope of the embodiments of the present invention which it is desired to protect herein.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept. Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context.

1. A method of conducting an enhanced electronic auction of an auction lot of a seller using a selected bidding method, said method comprising:
providing an auction server comprising:
an auction database comprising:
an auction profile record containing auction parameters and a selected bidding method for the auction of the auction lot;
a seller profile record containing seller details of the seller of the auction lot;
a plurality of bidder profile records, each bidder profile record corresponding to a registered bidder and containing verified bidder details; and
at least one bid record corresponding to a bid from a registered bidder in the auction;
auction software for conduct of the auction; and
a network interface by which client devices of a plurality of registered bidders can engage in two-way communication with the auction server;
conducting the auction of the auction lot by:
verifying the identification of the seller;
verifying the identification of each registered bidder;
during an auction bidding window:
displaying auction parameters from the auction profile record to registered bidders via the user interface of at least one client device in communication with the auction server;
allowing registered bidders to transmit bids conforming to the selected bidding method to the auction server via the user interface of at least one client device, each bid comprising a bid price and the details of a transmitted bid from seller to auction server comprising a bid transmission;
on receipt of a bid transmission to the auction server:
creating a bid record in the auction database corresponding to the transmitted bid, including linking said bid record to the corresponding bidder profile record; and
determining if the transmitted bid comprises the current winning bid in the auction based on the bidding parameters in the auction profile record, wherein if the transmitted bid is a new current winning bid the registered bidder corresponding thereto is the current winning bidder; and
determining the closure of the auction bidding window following which time no further transmitted bids will be accepted by the auction server;
following closure of the auction bidding window, finalizing the sale of the auction lot to the current winning bidder.

2. The method of conducting an enhanced electronic auction of claim 1 wherein the selected bidding method comprises a one way bidding process, wherein the bid with the highest bid price received within the auction bidding window is the winning bid.

3. The method of conducting an enhanced electronic auction of claim 2 wherein new bid transmissions will only be accepted by the auction server if the bid price of a bid transmission is higher than the bid price of the current winning bid.

4. The method of conducting an enhanced electronic auction of claim 2, wherein determining if a transmitted bid comprises the current winning bid comprises comparing the bid price of the transmitted bid to the bid price of the then current winning bid.

5. The method of conducting an enhanced electronic auction of claim 1, wherein the auction bidding window comprises a predetermined length of time.

6. The method of conducting an enhanced electronic auction of claim 5, wherein the auction bidding window is extended by a bidding window time extension each time that a new current winning bid is determined to have been received.

7. The method of conducting an enhanced electronic auction of claim 5, wherein the length of the auction bidding window is determined based on the details of transmitted bids received by the auction server.

8. The method of conducting an enhanced electronic auction of claim 7, wherein the auction bidding window is closed if a new current winning bid is not received within a predetermined period of time following the receipt of a current winning bid.

9. The method of conducting an enhanced electronic auction of claim 7 wherein the selected bidding method is a two way bidding process, and the method further comprises:
storing a seller price for the auction lot within the auction profile record, the seller price being a desired price at which the auction lot will be sold;
during the auction bidding window:
only allowing bids to be made by registered bidders for a bid price between the current seller price and the bid price of the current winning bid;
following receipt and determining of a new current winning bid, providing the seller the option to select a new current seller price which must be lower than the current seller price before any further bids from registered bidders are accepted;
if the seller selects a new current seller price, adjusting the display of same to registered bidders; and
terminating the auction bidding window when a current winning bid is received which has a bid price meeting the current seller price.

10. The method of conducting an enhanced electronic auction of claim 9 wherein the auction software requires registered bidders to make bids in predetermined bidding increments.

11. The method of conducting an enhanced electronic auction of claim 9, wherein a graph showing the current seller price and the bid price of winning bids received is displayed to registered bidders participating in the auction via their at least one client device.

12. The method of conducting an enhanced electronic auction of claim 1, wherein finalizing the sale of the auction lot to the current winning bidder comprises facilitating completion of payment from the current winning bidder to the seller, and delivery of the auction lot to the current winning bidder.

13. The method of conducting an enhanced electronic auction of claim 1, wherein the step of verifying the identification of the seller comprises capturing and verifying identification details of the seller.

14. The method of conducting an enhanced electronic auction of claim 1, wherein the step of verifying the identification of each registered bidder in respect of a particular auction comprises capturing and verifying identification details of the registered bidder.

15. The method of conducting an enhanced electronic auction of claim 14 further comprising obtaining a security deposit from the registered bidder before they will be allowed to place bids in auction of the auction lot.

16. The method of conducting an enhanced electronic auction of claim 15 wherein finalizing the sale of the auction lot to the current winning bidder comprises transferring the security deposit of the current winning bidder to the seller if the current winning bidder is otherwise unable to complete the sale.

17. The method of conducting an enhanced electronic auction of claim 1, wherein the client devices are selected from the group of:
personal computers;
smart devices; and
tablets.

18. The method of conducting an enhanced electronic auction of claim 1, wherein the number of auction profile records is more than one.

19. The method of conducting an enhanced electronic auction of claim 18, wherein the number of seller profile records is more than one.

20. The method of conducting an enhanced electronic auction of claim 1, wherein the auction parameters include a reserve price below which the auction lot will not be sold.

21. The method of conducting an enhanced electronic auction of claim 1, wherein the seller can accept the current winning bid and close the auction at any time during the auction bidding window.

22. The method of conducting an enhanced electronic auction of claim 1, wherein all bidding activity within the auction bidding window is visible to all registered bidders.

23. The method of conducting an enhanced electronic auction of claim 9 wherein the auction software requires registered bidders to make bids in predetermined bidding increments.

24. An auction server for use in the conduct of a method of conducting an enhanced electronic auction of an auction lot of a seller using a selected bidding method, said server comprising:
an auction database comprising:
an auction profile record containing auction parameters and a selected bidding method for the auction of the auction lot;
a seller profile record containing seller details of the seller of the auction lot;
a plurality of bidder profile records, each bidder profile record corresponding to a registered bidder and containing verified bidder details;
at least one bid record corresponding to a bid from a registered bidder in the auction;
auction software for conduct of the auction; and
a network interface by which client devices of a plurality of registered bidders can engage in two-way communication with the auction server;
wherein said auction software will conduct the auction of the auction lot by:
creating the seller profile record and verifying the identification of the seller;
creating the plurality of bidder profile records and verifying the identification of each registered bidder;
during an auction bidding window:
displaying auction parameters from the auction database to registered bidders via the user interface of at least one client device;
allowing registered bidders to transmit bids conforming to the selected bidding method to the auction server via the user interface of at least one client device, each bid comprising a bid price and the details of a transmitted bid from seller to auction server comprising a bid transmission;
on receipt of a bid transmission by the auction server:
creating a bid record in the auction database corresponding to the transmitted bid, including linking said bid record to the corresponding bidder profile record; and
determining if the transmitted bid comprises the current winning bid in the auction based on the bidding parameters in the auction profile record, wherein if the transmitted bid is a new current winning bid the registered bidder corresponding thereto is the current winning bidder; and
determining the closure of the auction bidding window following which time no further transmitted bids will be accepted by the auction server;
following closure of the auction bidding window, finalizing the sale of the auction lot to the current winning bidder.

25. The auction server of claim 24, wherein determining if a transmitted bid comprises the current winning bid comprises comparing the bid price of the transmitted bid to the bid price of the then current winning bid.

26. The method of conducting an enhanced electronic auction of claim 24, wherein the auction bidding window comprises a predetermined length of time.

27. The method of conducting an enhanced electronic auction of claim 26, wherein the auction bidding window is extended by a bidding window time extension each time that a new current winning bid is determined to have been received. The method of conducting an enhanced electronic auction of claim 5, wherein the length of the auction bidding window is determined based on the details of transmitted bids received by the auction server.

28. The auction server of claim 24, wherein the length of the auction bidding window is determined based on the details of transmitted bids received by the auction server.

29. The auction server of claim 28, wherein the auction bidding window is closed if a new current winning bid is not received within a predetermined period of time following the receipt of a current winning bid.

30. The auction server of claim 28 wherein the selected bidding method is a two way bidding process, and the method further comprises:
storing a seller price for the auction lot within the auction profile record, the seller price being a desired price at which the auction lot will be sold;
during the auction bidding window:
only allowing bids to be made by registered bidders for a bid price between the current seller price and the bid price of the current winning bid;
following receipt and determining of a new current winning bid, providing the seller the option to select a new current seller price which must be lower than the current seller price before any further bids from registered bidders are accepted;
if the seller selects a new current seller price, adjusting the display of same to registered bidders; and
terminating the auction bidding window when a current winning bid is received which has a bid price meeting the current seller price.

31. The auction server of claim 30, wherein the auction software displays a graph showing the current seller price and the bid price of winning bids received to registered bidders participating in the auction via their at least one client device.

32. A non-transitory computer-readable storage medium being an auction software program, the computer-readable storage medium including instructions that when executed by an auction server operatively connected to a computer network, enable the auction server to facilitate a method of conducting an enhanced electronic auction by:
administering an auction database operatively connected to the auction server, said auction database comprising:
an auction profile record containing auction parameters and a selected bidding method for the auction of the auction lot;
a seller profile record containing seller details of the seller of the auction lot;
a plurality of bidder profile records, each bidder profile record corresponding to a registered bidder and containing verified bidder details; and
at least one bid record corresponding to a bid from a registered bidder in the auction;
conducting an auction of an auction lot by:
creating a seller profile record corresponding to a seller;
storing the results of verification of the identification of the seller to the seller profile record;
creating a plurality of bidder profile records corresponding to a plurality of registered bidders;
storing the results of verification of the identification of each registered bidder to the corresponding bidder profile record;
during an auction bidding window:
displaying auction parameters from the auction profile record for the auction to registered bidders via the user interface of at least one client device in communication with the auction server;
allowing registered bidders to transmit bids conforming to the selected bidding method to the auction server via the user interface of at least one client device, each bid comprising a bid price and the details of a transmitted bid from seller to auction server comprising a bid transmission;
on receipt of a bid transmission to the auction server:
creating a bid record in the auction database corresponding to the transmitted bid, including linking said bid record to the corresponding bidder profile record; and
determining if the transmitted bid comprises the current winning bid in the auction based on the bidding parameters in the auction profile record, wherein if the transmitted bid is a new current winning bid the registered bidder corresponding thereto is the current winning bidder; and
determining the closure of the auction bidding window following which time no further transmitted bids will be accepted by the auction server;
following closure of the auction bidding window, finalizing the sale of the auction lot to the current winning bidder.

33. The non-transitory computer-readable storage medium of claim 32 wherein the selected bidding method comprises a one way bidding process, wherein the bid with the highest bid price received within the auction bidding window is the winning bid.

34. The non-transitory computer-readable storage medium of claim 33 wherein new bid transmissions will only be accepted by the auction server if the bid price of a bid transmission is higher than the bid price of the current winning bid.

35. The non-transitory computer-readable storage medium of claim 33, wherein determining if a transmitted bid comprises the current winning bid comprises comparing the bid price of the transmitted bid to the bid price of the then current winning bid.

36. The non-transitory computer-readable storage medium of claim 32, wherein the auction bidding window comprises a predetermined length of time.

37. The non-transitory computer-readable storage medium of claim 36, wherein the auction bidding window is extended by a bidding window time extension each time that a new current winning bid is determined to have been received.

38. The non-transitory computer-readable storage medium of claim 36, wherein the length of the auction bidding window is determined based on the details of transmitted bids received by the auction server.

39. The non-transitory computer-readable storage medium of claim 38, wherein the auction bidding window is closed if a new current winning bid is not received within a predetermined period of time following the receipt of a current winning bid.

40. The non-transitory computer-readable storage medium of claim 38 wherein the selected bidding method is a two way bidding process, and the method further comprises:
storing a seller price for the auction lot within the auction profile record, the seller price being a desired price at which the auction lot will be sold;
during the auction bidding window:
only allowing bids to be made by registered bidders for a bid price between the current seller price and the bid price of the current winning bid;
following receipt and determining of a new current winning bid, providing the seller the option to select a new current seller price which must be lower than the current seller price before any further bids from registered bidders are accepted;
if the seller selects a new current seller price, adjusting the display of same to registered bidders; and
terminating the auction bidding window when a current winning bid is received which has a bid price meeting the current seller price.

41. The non-transitory computer-readable storage medium of claim 40, wherein a graph showing the current seller price and the bid price of winning bids received is displayed to registered bidders participating in the auction via their at least one client device.

42. The non-transitory computer-readable storage medium of claim 32, wherein the seller can accept the current winning bid and close the auction at any time during the auction bidding window.
